(19) United States
(12) Patent Application Publication
(10) Pub. No.: US 2009/0030882 A1
(43) Pub. Date: Jan. 29, 2009

(54) DOCUMENT IMAGE PROCESSING APPARATUS AND DOCUMENT IMAGE PROCESSING METHOD

(76) Inventors: Bo Wu, Shanghai (CN); Jianjun Dou, Shanghai (CN); Ning Le, Shanghai (CN); Yadong Wu, Shanghai (CN); Jing Jia, Shanghai (CN)

Correspondence Address: BIRCH STEWART KOLASCH & BIRCH, PO BOX 747, FALLS CHURCH, VA, 22040-0747, US

(21) Appl. No.: 11/972,476

(22) Filed: Jan. 10, 2008

(30) Foreign Application Priority Data
Jul. 23, 2007 (CN) 200710129608.4

(51) Int. Cl. G06F 7/06; G06F 17/30

(52) U.S. Cl. 707/3; 707/E17.014

(57) ABSTRACT

There is provided a document image processing apparatus which can reduce troubles to find a desired heading from a document image. A heading region extracting portion searches an index information DB and extracts a heading region containing a search keyword. An order setting portion automatically sets in line with a predetermined rule an order of the heading regions extracted by the heading region extracting portion. On a displaying portion is displayed a document image on which the heading regions extracted by the heading region extracting portion are highlighted in accordance with the order set by the order setting portion. A display order of search results may be set by determining importance of the extracted heading regions based on the number of the search keyword and features of character images in the heading regions.

### CROSS-REFERENCE TO RELATED APPLICATION

This application claims priority to Chinese Patent Application No. 200710129608.4, which was filed on Jul. 23, 2007, the contents of which are incorporated herein by reference in its entirety.

### BACKGROUND OF THE INVENTION

1. Field of the Invention

The present invention relates to a document image processing apparatus and method for inputting and storing a document as an image, more specifically to a document image processing apparatus having a function of searching stored document images, and to a document image processing method using the function.

Further, the present invention relates to a document image processing program and recording medium for inputting and storing a document as an image.

2. Description of the Related Art

A document filing apparatus has been put into practical use, which utilizes an image inputting device such as an image scanner to convert a document into an image and electronically store the document image, and enables searching of the document image later on. A technique relating to the document filing apparatus just mentioned has been disclosed in Chinese Unexamined Patent Publications CN1402854A, CN1535430A and CN1851713A.

A related art document filing apparatus merely searches for a search keyword and displays a search result, and a user therefore needs to find a desired heading from the displayed search result. Accordingly, there is a problem of causing troubles to find the desired heading.

### SUMMARY OF THE INVENTION

An object of the invention is to provide a document image processing apparatus and method capable of reducing time and labor to find a desired heading from a document image.

The invention provides a document image processing apparatus comprising:

a heading region storing portion for storing as a candidate character a character image having a high degree of similarity on each of character images in a plurality of heading regions in a document image;

a heading region extracting portion for extracting a heading region containing a search keyword by searching the heading region storing portion for each of search characters constituting the search keyword in an inputted search formula;

an order setting portion for setting in line with a predetermined rule an order of the heading regions extracted by the heading region extracting portion; and

a displaying portion for displaying a document image and highlighting on the displayed document image the heading regions extracted by the heading region extracting portion, in accordance with the order set by the order setting portion.

According to the invention, the heading region extracting portion searches the heading region storing portion and extracts the heading regions containing the search keyword. In line with the predetermined rule, the order setting portion sets the order of the heading regions extracted by the heading region extracting portion. On the displaying portion is displayed the document image on which the heading regions extracted by the heading region extracting portion are highlighted in accordance with the order set by the order setting portion. It is thus possible to reduce troubles of finding the desired heading from the document image.

Further, in the invention, it is preferable that the heading region storing portion further stores position information of the plurality of the heading regions in the document image, and

the order setting portion sets the order of the heading region extracted by the heading region extracting portion, based on the position information of the heading region in the document image.

According to the invention, on the basis of the position information of the heading region in the document image, the order setting portion sets the order of the heading region extracted by the heading region extracting portion extracted by the heading region extracting portion. This enables to precisely set the order and further reduce the troubles of finding the desired heading from the document image.

Further, in the invention, it is preferable that, in a case where a number of search keywords contained in the inputted search formula is plural, the order setting portion sets the order of the heading regions extracted by the heading region extracting portion, based on the number of search keywords contained in the heading region.

According to the invention, in the case where the number of search keywords contained in the inputted search formula is plural, the order setting portion sets the order of the heading regions extracted by the heading region extracting portion, based on the number of search keywords contained in the heading region. This enables to precisely set the order and further reduce the troubles of finding the desired heading from the document image.

Further, in the invention, it is preferable that the order setting portion sets the order of the heading regions extracted by the heading region extracting portion, based on a number of characters in a character string part which is partially or totally in similarity with the search keyword.

According to the invention, the order setting portion sets the order of the heading regions extracted by the heading region extracting portion, based on the number of characters in the character string part which is partially or totally in similarity with the search keyword. This enables to precisely set the order and further reduce the troubles of finding the desired heading from the document image.

Further, in the invention, it is preferable that the order setting portion sets the order of the heading regions extracted by the heading region extracting portion, based on a size of a character image contained in the heading regions.

According to the invention, the order setting portion sets the order of the heading regions extracted by the heading region extracting portion, based on the size of the character images contained in the heading regions. This enables to precisely set the order and further reduce the troubles of finding the desired heading from the document image.

Further, in the invention, it is preferable that the order setting portion modifies a setting of the order of the heading regions extracted by the heading region extracting portion, in accordance with an inputted order-modifying command.

According to the invention, the order setting portion modifies the setting of the order of the heading regions extracted by the heading region extracting portion, in accordance with an inputted order-modifying command. The order can be thus reset according to need, and adaptability can be enhanced concerning the setting of the order.

Further, in the invention, it is preferable that the displaying portion is capable of setting a display mode of highlight.

According to the invention, the displaying portion can set the display mode of highlight, with the result that a demand for individualization can be satisfied.

The invention provides a document image processing method comprising:

a heading region storing step for storing as a candidate character a character image having a high degree of similarity on each of character images in a plurality of heading regions in a document image;

a heading region extracting step for extracting a heading region containing a search keyword by searching information stored in the heading region storing step for each of search characters constituting the search keyword in an inputted search formula;

an order setting step for setting in line with a predetermined rule an order of the heading regions extracted in the heading region extracting step; and

a displaying step for displaying a document image and highlighting the heading regions extracted in the heading region extracting step, in accordance with the order set in the order setting step.

According to the invention, at the heading region extracting step, the information stored at the heading region storing step is searched, and the heading regions containing the search keyword are extracted. In the order setting step, the order of the heading regions extracted in the heading region extracting step is set in line with the predetermined rule. In the displaying step, the document image is displayed, and on the document image, the heading regions extracted in the heading region extracting step is highlighted in accordance with the order set in the order setting step. It is thus possible to reduce troubles of finding the desired heading from the document image.

Further, the invention provides a document image processing program for causing a computer to perform the document image processing method.

Further, the invention provides a computer-readable recording medium on which is recorded a document image processing program for causing a computer to perform the document image processing method.

According to the invention, it is possible to provide the document image processing program and the computer-readable recording medium on which the document image processing program is recorded.

### BRIEF DESCRIPTION OF THE DRAWINGS

Other and further objects, features, and advantages of the invention will be more explicit from the following detailed description taken with reference to the drawings wherein:

FIG. 1 is a block diagram showing a constitution of chief part of a document image processing apparatus according to one embodiment of the invention;

FIG. 2 is a block diagram schematically showing a constitution of the document image processing apparatus;

FIG. 3 is a view of assistance in briefly explaining a searching operation of the document image processing apparatus;

FIG. 4 is a view showing one example of a display screen displayed on a displaying portion;

FIG. 5A is a flowchart of assistance in explaining a first example of an order setting operation of an order setting portion;

FIG. 5B is a flowchart of assistance in explaining a second example of the order setting operation of the order setting portion;

FIG. 5C is a flowchart of assistance in explaining a third example of the order setting operation of the order setting portion;

FIG. 6 is a view showing one example of a display screen ready for modifying a setting of order;

FIG. 7 is a flowchart of assistance in explaining an order modifying operation of the order setting portion;

FIG. 8 is a flowchart of assistance in explaining the fourth example of the order setting operation of the order setting portion;

FIG. 9 is a view showing one example of a dialog box for modifying a display mode of highlight;

FIGS. 10A and 10B are block diagrams showing in detail the constitution of the document image processing apparatus;

FIG. 11 is an illustration showing a process on how to prepare a character shape specimen database;

FIG. 12 is an illustration of a character image peripheral feature;

FIGS. 13A and 13B are illustrations of grid-direction-wise features;

FIG. 14 is an illustration showing a process on how to prepare a character image feature dictionary;

FIG. 15 is an illustration showing a process on how to prepare an index information database;

FIG. 16 is an illustration showing a specific example of a process on how to prepare an index matrix;

FIG. 17 is an illustration showing an example of a document image and a data placement example of index information of the document image in the index information database;

FIG. 18 is an illustration showing functions and a searching process of a searching section;

FIG. 19 is a flowchart showing a search procedure in the searching section;

FIG. 20 is an illustration showing a method of calculating a degree of correlation between a search keyword and an index matrix;

FIG. 21 is an illustration showing a specific example on how to calculate the degree of correlation between the search keyword and the index matrix;

FIG. 22 is an illustration showing a search process provided with a lexical analysis function;

FIG. 23 is an illustration showing a process in a document image managing portion;

FIG. 24 is an illustration showing a specific example of a process on how to adjust a character string of a first column in the prepared index matrix into a character string which makes sense; and

FIG. 25 is an illustration showing browsing screens, displayed by a document image displaying portion, of a document image stored in a document image DB.

### DETAILED DESCRIPTION

Now referring to the drawings, preferred embodiments of the invention are described below.

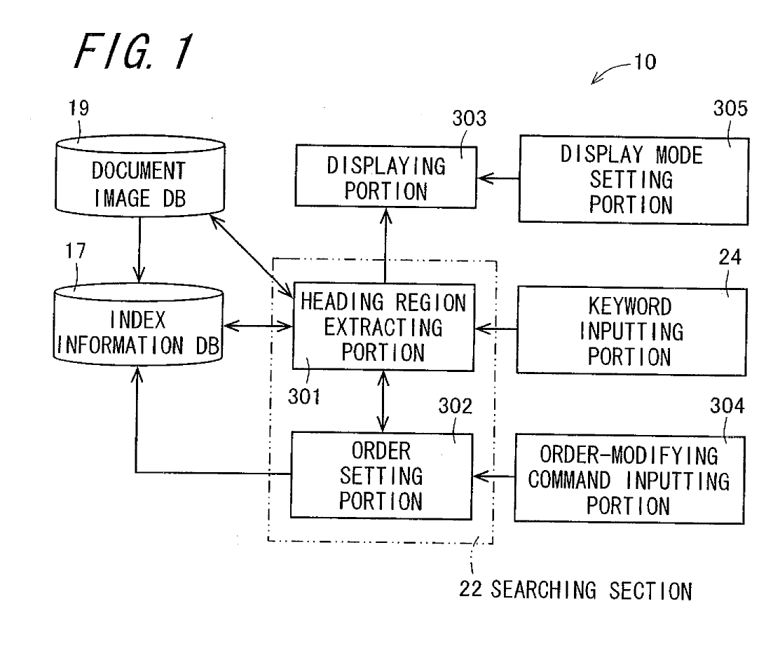

FIG. 1 is a block diagram showing a constitution of chief part of a document image processing apparatus 10 according to one embodiment of the invention. The document image processing apparatus 10 is used to input a document therein as an image, store the image, search a document image stored therein, and browse the document image.

The document image processing apparatus 10 includes a document image database (document image DB) 19, an index information database (index information DB) 17 serving as a heading region storing portion, a keyword inputting portion 24, a heading region extracting portion 301, an order setting portion 302, a displaying portion 303, an order-modifying command inputting portion 304, and a display mode setting portion 305.

The document image DB 19 assigns a document ID for identification to a document image, and stores the document image with the document ID. The index information DB 17 stores index information which relates to a plurality of heading regions contained in the document image. Into the keyword inputting portion 24, a search keyword is inputted.

The heading region extracting portion 301 searches the index information DB 17 and extracts a heading region which contains the search keyword. In line with a predetermined rule, the order setting portion 302 sets an order of the heading regions extracted by the heading region extracting portion 301. The heading region extracting portion 301 as just described constitutes a searching section 22 together with an order setting portion 302.

The displaying portion 303 displays the document image stored in the document image DB 18 and moreover on the document image thus displayed, the displaying portion 303 highlights, in accordance with the order set by the order setting portion 302, the heading region extracted by the heading region extracting portion 301.

Into the order-modifying command inputting portion 304 is inputted an order-modifying command for modifying a setting of order of the heading region extracted by the heading region extracting portion 301. Into the display mode setting portion 305 is inputted a command for setting a display mode of the highlight effected by the displaying portion 303.

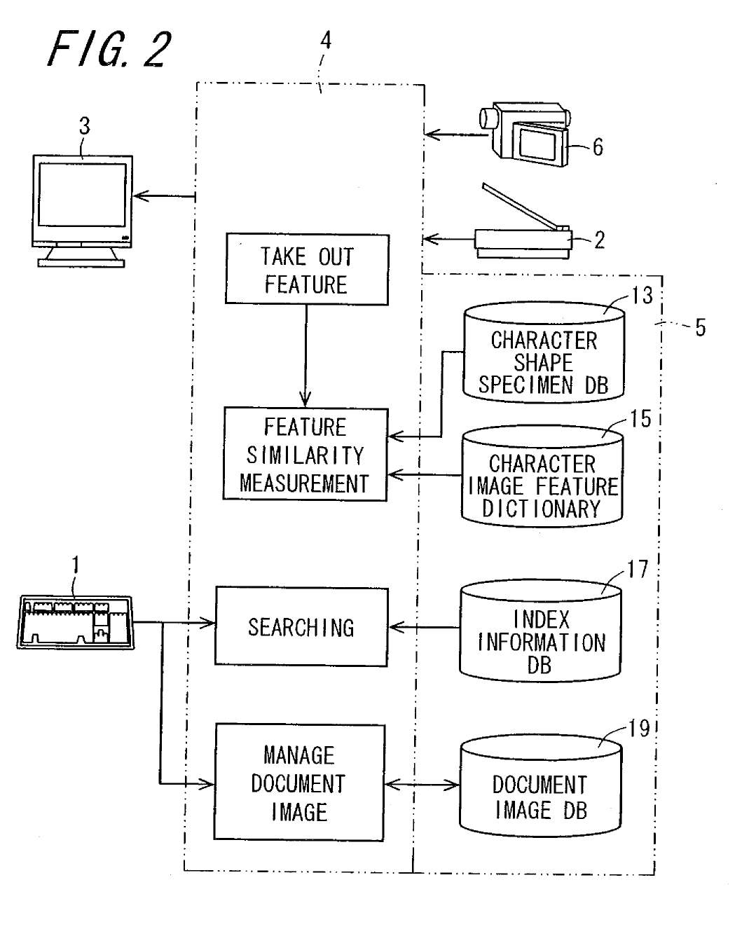

FIG. 2 is a block diagram schematically showing a constitution of the document image processing apparatus 10. The document image processing apparatus 10 includes a processor 4 and an external storage device 5. The external storage device 5 stores software etc. which is used by the processor 4 to perform an actual processing.

The processor 4 performs actually a document image feature extracting process, an index information producing process, a search process, a document image managing process, and the like. In the document image feature extracting process, a search key heading region is clipped from a document image. In the index information producing process, index information is produced that makes it possible to search the document image. The index information is used in the search process. In the document image managing process, a meaningful document name is prepared by use of the index information so as to manage the document image. The meaningful document name will be described later on.

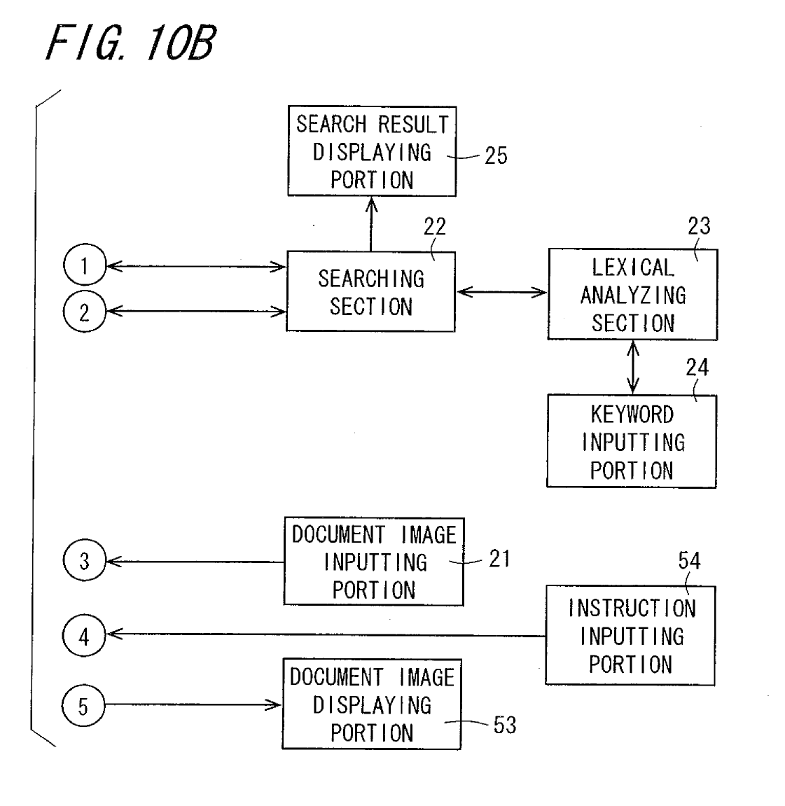

The actual processing of the processor 4 is performed by use of the software stored in the external storage device 5. The processor 4 is constructed of, for example, a main body of a common computer. In the present embodiment, the processor 4 is so provided as also to be able to perform a character image feature dictionary preparing process. In the character image feature dictionary preparing process, a character image feature dictionary 15 (refer to FIGS. 10A and 10B) is prepared which is used in the index information producing process and will be described later on.

The external storage device 5 can be constructed of, for example, a fast accessible hard disk. For the sake of holding a large quantity of document images, it is acceptable that the external storage device 5 is constructed of a high-capacity device such as an optical disc. The external storage device 5 is designed for use in preparing the character image feature dictionary 15, an index information DB 17, a document image DB 19, a character shape specimen database (character shape specimen DB) 13, and the like component, which will be described later on.

A keyboard 1 and a display device 3 are connected simultaneously to the document image processing apparatus 10. The keyboard 1 is used for inputting a search keyword. In addition, the keyboard 1 is also used for inputting an instruction at the time of browsing a document image. Further, the keyboard 1 is also used for modifying set values, such as the number of candidate characters, a correlation value, and a degree-of-correlation weighting factor for rows Q, which will be described later on. The display apparatus 3 outputs and thereby displays the document image, etc. The content displayed by the display device 3 includes degree-of-correlation information, an image name, and the like information.

An image scanner 2 or a digital camera 6 is further connected to the document image processing apparatus 10. The image scanner 2 and the digital camera 6 are used for acquiring the document image. A way to acquire the document image is, however, not limited to the way where the image scanner 2 or the digital camera 6 is used. The acquirement of the document image may be realized by communication across a network, and the like. In addition, the image scanner 2 or the digital camera 6 may be used to input the search keyword.

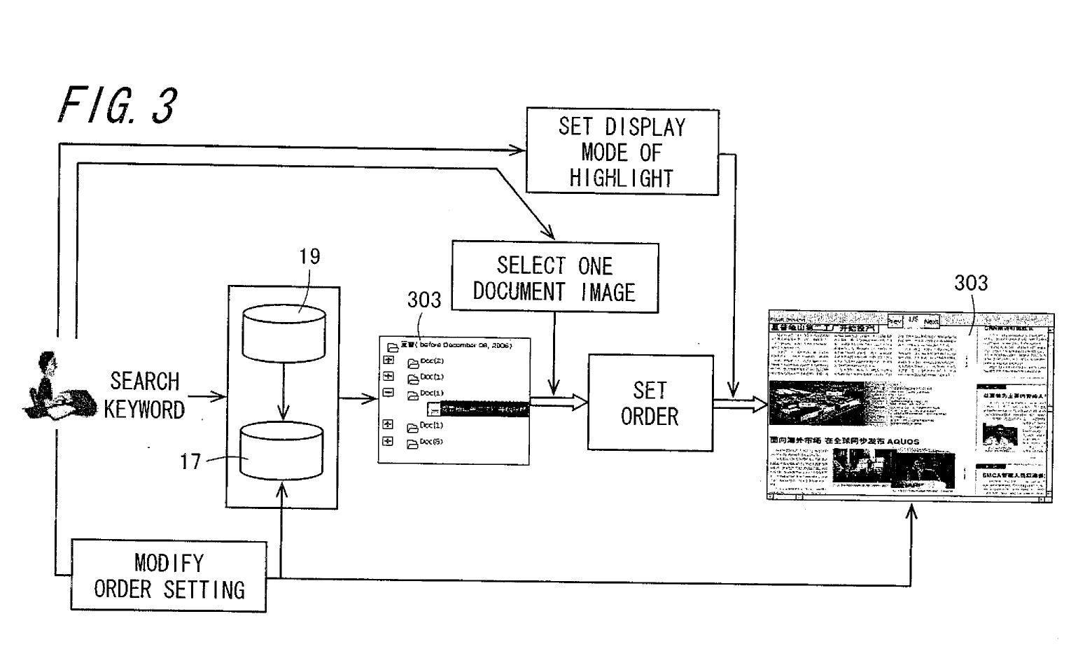

FIG. 3 is a view of assistance in briefly explaining a searching operation of the document image processing apparatus 10. In the document image DB 19, a plurality of document images are stored. In the index information DB 17, the index information is stored for respective document images stored in the document image DB 19.

When the search keyword is inputted into the keyword inputting portion 24 to perform the search, the index information DB 17 is searched by the searching section 22, and a document image in similarity with the search keyword is extracted. On the displaying portion 303, a list of document names of the extracted document images is displayed.

When one document image is selected by selecting a document name thereof displayed on the displaying portion 303, the heading region extracting portion 301 of the searching section 22 searches the index information DB 17 and extracts the heading region containing the search keyword from the one document image which was selected. And then, in line with a predetermined rule, the order setting portion 302 of the searching section 22 sets the order of the heading region extracted by the heading region extracting portion 301.

Subsequently, on the displaying portion 303 is displayed the one document image which was selected, and moreover on the displayed document image, the heading region extracted by the heading region extracting portion 301 is highlighted in accordance with the order set by the order setting portion 302. It is thus possible to reduce troubles of finding a desired heading from the document image.

When the order-modifying command is inputted by the order-modifying command inputting portion 304, the order setting portion 302 modifies the setting of the order of the heading region extracted by the heading region extracting portion 301, in accordance with the inputted order-modifying command. And on the displaying portion 303, the heading region extracted by the heading region extracting portion 301 is highlighted in accordance with the order modified by the order setting portion 302. Such a constitution may be adapted that information about the change of setting as just stated is stored in the index information DB 17 to be utilized in setting the order at a next searching occasion.

When a command for setting the display mode of the highlight effected by the displaying portion 303 is inputted into the display mode setting portion 305, the displaying portion 303 sets the display mode of the highlight effected by the displaying portion 303 in response to the inputted command. On the displaying portion 303, the heading region extracted by the heading region extracting portion 301 is highlighted on the displayed document image in the set display mode in accordance with the order set by the order setting portion 302.

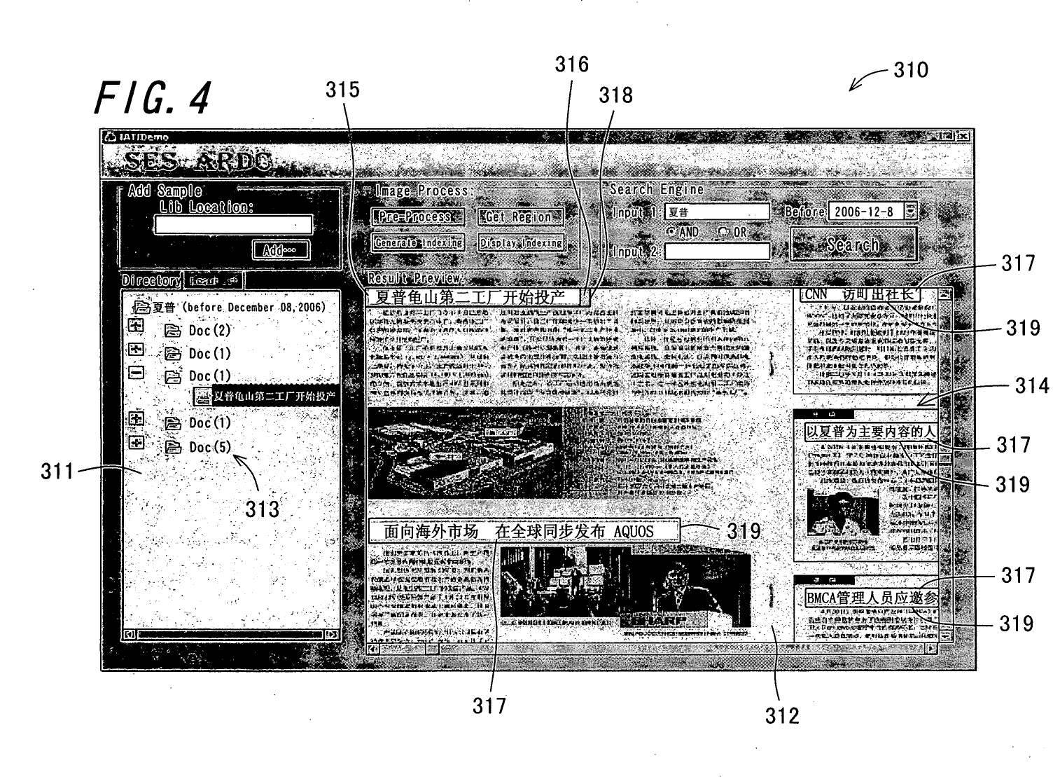

FIG. 4 is a view showing one example of a display screen 310 displayed on the displaying portion 303. The display screen 310 has a document name display region 311 for displaying a list of document names 313 of the document images, and a document image display region 312 for displaying the document image. The document name display region 311 is located on the left side in the display screen 310 while the document image display region 312 is located on the right side in the display screen 310. By selecting the document name 313 of the document image displayed in the document name display region 311, the document image corresponding to the selected document name is selected. And on the document image display region 312, the selected document image 314 is displayed. A heading region 316 whose order is the top is located at a predetermined set position inside the document image display region 312. The set position is determined, for example, at an upper-left position 315 inside the document image display region 312.

The heading region 316 (hereinafter referred to as “a main region”) whose order is the top is highlighted in the first display mode, and a heading portion 317 (hereinafter referred to as “a sub region”) whose order follows the top is highlighted in the second display mode which is different from the first display mode. In the present embodiment, the main region 316 is surrounded by an enclosing line 318 of the first color while the sub region 317 is surrounded by an enclosing line 319 of the second color which is different from the first color. The main region 316 and the sub region 317 are thus highlighted in a distinguishable manner. The display mode of highlight is set respectively for the main region 316 and for the sub region 317.

The above-described display mode is one example, and a display mode is not limited to the above-described display mode. For example, the main region 316 and the sub region 317 may be distinguished with each other by a difference not in color but in line type or line width. Furthermore, the enclosing line may be replaced by an underline.

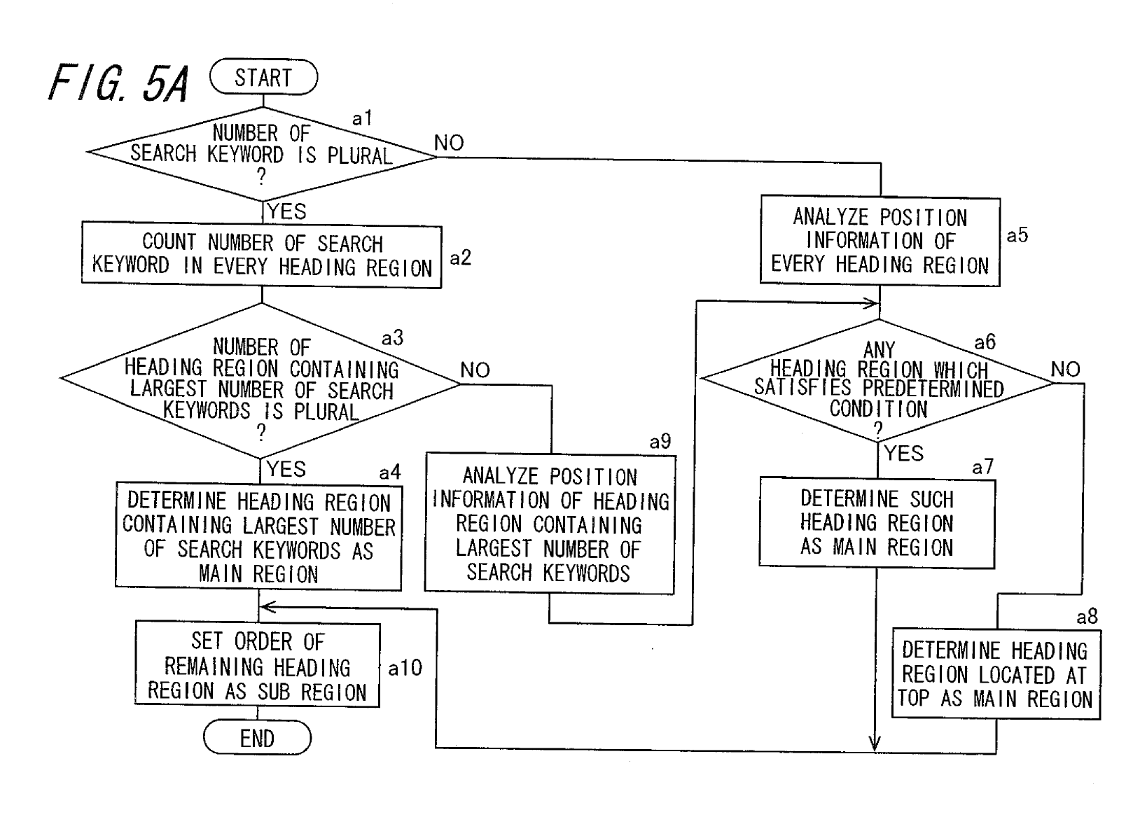

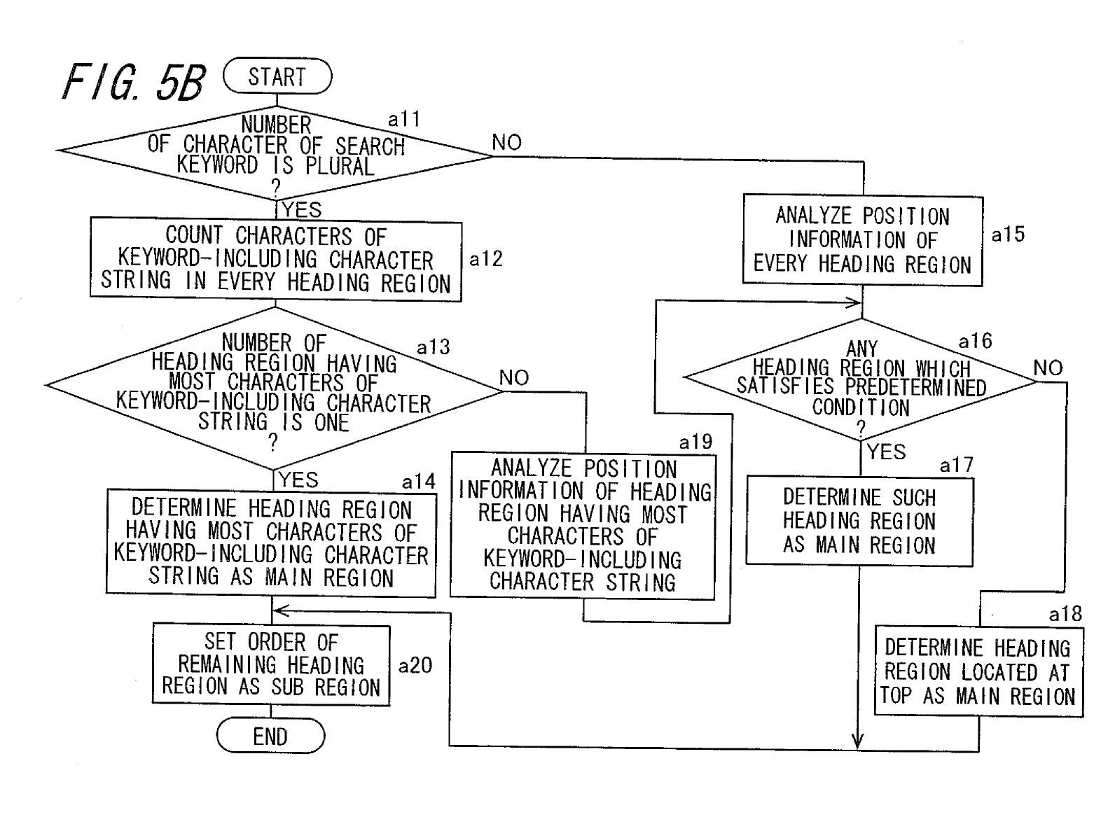

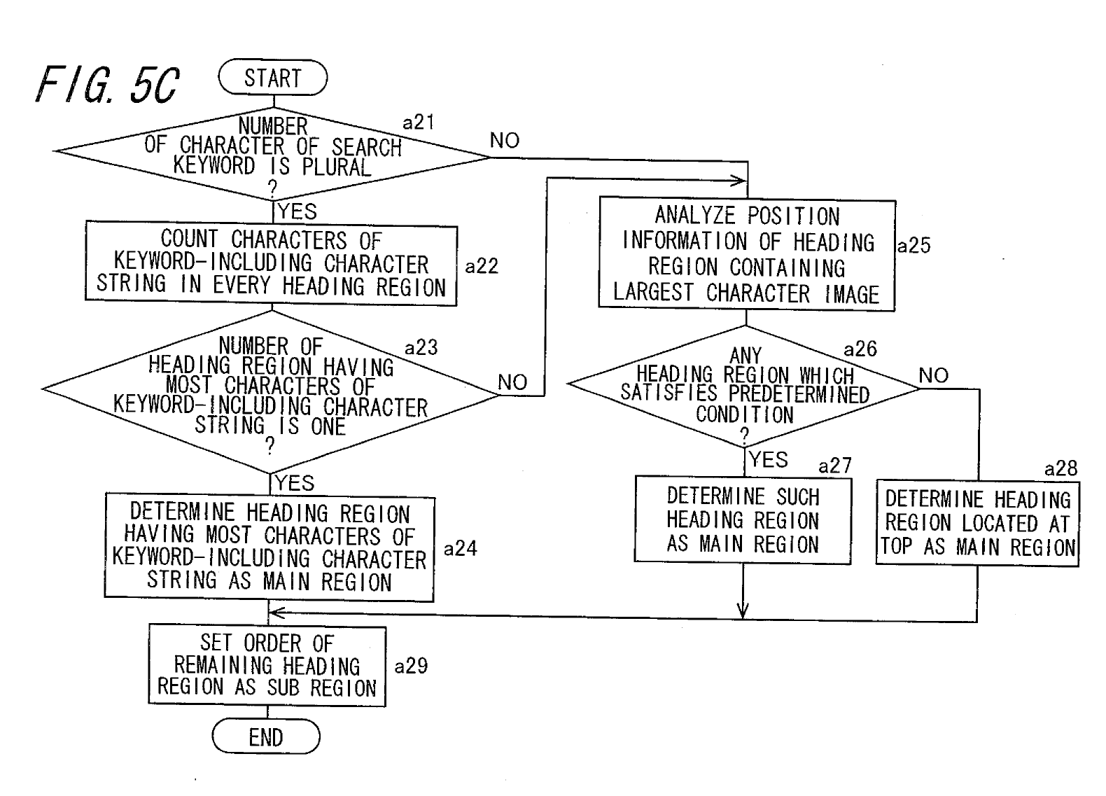

FIG. 5A is a flowchart of assistance in explaining a first example of an order setting operation of the order setting portion 302. When one document image is selected by selecting one of the document names 313 of the document images displayed in the document name display region 311, the heading region extracting portion 310 searches the index information DB 17 and extracts the heading region containing the search keyword from the one selected document image. When the heading region containing the search keyword is extracted from the one selected document image, the order setting portion 302 initiates the order setting operation.

When the order setting operation starts, first of all, in Step a1, the order setting portion 302 determines whether or not the number of search keyword in the search formula is plural. When the number of search keyword in the search formula is plural, the process goes to Step a2. When the number of search keyword in the search formula is one, the process goes to Step a5.

In Step a2, the number of search keyword is counted in every one of the extracted heading regions. Next, in Step a3, the order setting portion 302 determines whether or not the number of heading region containing the largest number of search keywords is one. When the number of heading region containing the largest number of search keywords is one, the process goes to Step a4. When the number of heading region containing the largest number of search keywords is plural, the process goes to Step a9.

In Step a5, position information of every one of the extracted heading regions in the document image is analyzed. Next, Step a6, the order setting portion 302 determines whether or not there is any heading region which is positioned on the top left side of the document image and distanced away from another heading region with a space exceeding a predetermined threshold value T. When the order setting portion 302 determines the presence of the heading region as described above, the process goes to Step a7. When the order setting portion 302 determines the absence of the heading region as described above, the process goes to Step a8.

In Step a9, position information of a plurality of the heading regions containing the largest number of search keywords in the document image is analyzed. The process then goes to Step a6.

In Step a4, the heading region containing the largest number of search keywords is determined as a main region. In Step a7, determined as a main region is a heading region which is positioned on the top left side of the document image and distanced away from another heading region with a space exceeding the predetermined threshold value T. In Step a8, the heading region located at the top position among all the extracted heading regions is determined as a main region.

In Step a10 after the main region is determined, the order of remaining heading regions except the main region among the extracted heading regions is set in the same processing method. The remaining heading portion is determined as a sub region. The order setting operation is then brought to the end.

As described above, the order setting portion 302 sets the order of the heading region extracted by the heading region extracting portion 301, based on the position information of the heading region in the document image. This enables to precisely set the order and further reduce the troubles of finding the desired heading from the document image.

Further, in the case where the number of search keyword contained in the inputted search formula is plural, the order setting portion 302 sets the order of the heading region extracted by the heading region extracting portion 301, based on the number of search keyword contained in the heading region. This enables to precisely set the order and further reduce the troubles of finding the desired heading from the document image.

FIG. 5B is a flowchart of assistance in explaining a second example of the order setting operation of the order setting portion 302. The order setting operation of the second example is similar to the order setting operation of the first example. Accordingly, in the following descriptions of the order setting operation of the second example, some points which are the same as those of the first example will be omitted. In the second example, the order setting portion 302 initiates the order setting operation in the same manner as in the case of the first example.

When the order setting operation starts, first of all, in Step a11, the order setting portion 302 determines whether or not the number of characters of search keyword is plural. When the number of characters of search keyword is plural, the process goes to Step a12. When the number of characters of search keyword is one, the process goes to Step a15.

Herein, the characters in a character string part which is partially or totally in similarity with the search keyword, is referred to as the characters of keyword-including character string. In Step a12, the characters of keyword-including character string are counted for every one of the extracted heading regions. Next, in Step a13, the order setting portion 302 determines whether or not the number of heading region having the largest number of characters of keyword-including character string is one. When the number of heading region having the largest number of characters of keyword-including character string is one, the process goes to Step a14. When the number of heading region having the largest number of characters of keyword-including character string is plural, the process goes to Step a19.

In Step a14, the heading region having the largest number of characters of keyword-including character string is determined as a main region. Steps a15 to a1 are the same as Steps a5 to a8 in the first example. In Step a19, position information in the document image is analyzed, of a plurality of the heading regions having the largest number of characters of keyword-including character string. The process then goes to Step a16.

After the main region is determined, the process goes to Step a20 which is the same as Step a10. The order setting operation is then brought to the end.

As described above, in the second example, the order setting portion 302 sets the order of the heading region extracted by the heading region extracting portion 301, based on the position information of the heading region in the document image, as in the case of the first example. This enables to precisely set the order and further reduce the troubles of finding the desired heading from the document image.

Further, in the second example, the order setting portion 302 sets the order of the heading region extracted by the heading region extracting portion 301, based on the number of characters in the character string part which is partially or totally in similarity with the search keyword. This enables to precisely set the order and further reduce the troubles of finding the desired heading from the document image.

FIG. 5C is a flowchart of assistance in explaining a third example of the order setting operation of the order setting portion 302. The order setting operation of the third example is similar to the order setting operation of the first example. Accordingly, in the following descriptions of the order setting operation of the third example, some points which are the same as those of the first example will be omitted. In the third example, the order setting portion 302 initiates the order setting operation in the same manner as in the case of the first example.

When the order setting operation starts, first of all, in Step a21, the order setting portion 302 determines whether or not the number of characters of search keyword is plural. When the number of characters of search keyword is plural, the process goes to Step a22. When the number of characters of search keyword is one, the process goes to Step a25.

In Step a22, the characters of keyword-including character string are counted for every one of the extracted heading regions. As stated above, the characters of keyword-including character string indicate the characters in a character string part which is partially or totally in similarity with the search keyword. Next, in Step a23, the order setting portion 302 determines whether or not the number of heading region having the largest number of characters of keyword-including character string is one. When the number of heading region having the largest number of characters of keyword-including character string is one, the process goes to Step a24. When the number of heading region having the largest number of characters of keyword-including character string is plural, the process goes to Step a25.

In Step a24, the heading region having the largest number of characters of keyword-including character string is determined as a main region. In Step a25, position information in the document image is analyzed, of a heading region containing a character image whose size is the largest. The size of the character image may indicate a heightwise or widthwise size of a character in the character image. Alternatively, the size of the character image may indicate a diagonal size of the character image. Furthermore, the size of the character image may indicate an area of the character image. The process then goes to Step a26. Steps a26 to a28 are the same as Steps a6 to a8 in the first example.

After the main region is determined, the process goes to Step a29 which is the same as Step a10. The order setting operation is then brought to the end.

As described above, in the third example, the order setting portion 302 sets the order of the heading region extracted by the heading region extracting portion 301, based on the position information of the heading region in the document image, as in the case of the first example. This enables to precisely set the order and further reduce the troubles of finding the desired heading from the document image.

Further, in the third example, the order setting portion 302 sets the order of the heading region extracted by the heading region extracting portion 301, based on the number of characters in the character string part which is partially or totally in similarity with the search keyword. This enables to precisely set the order and further reduce the troubles of finding the desired heading from the document image.

Furthermore, in the third example, the order setting portion 302 sets the order of the heading region extracted by the heading region extracting portion 301, based on the size of the character image contained in the heading region. This also enables to precisely set the order and further reduce the troubles of finding the desired heading from the document image.

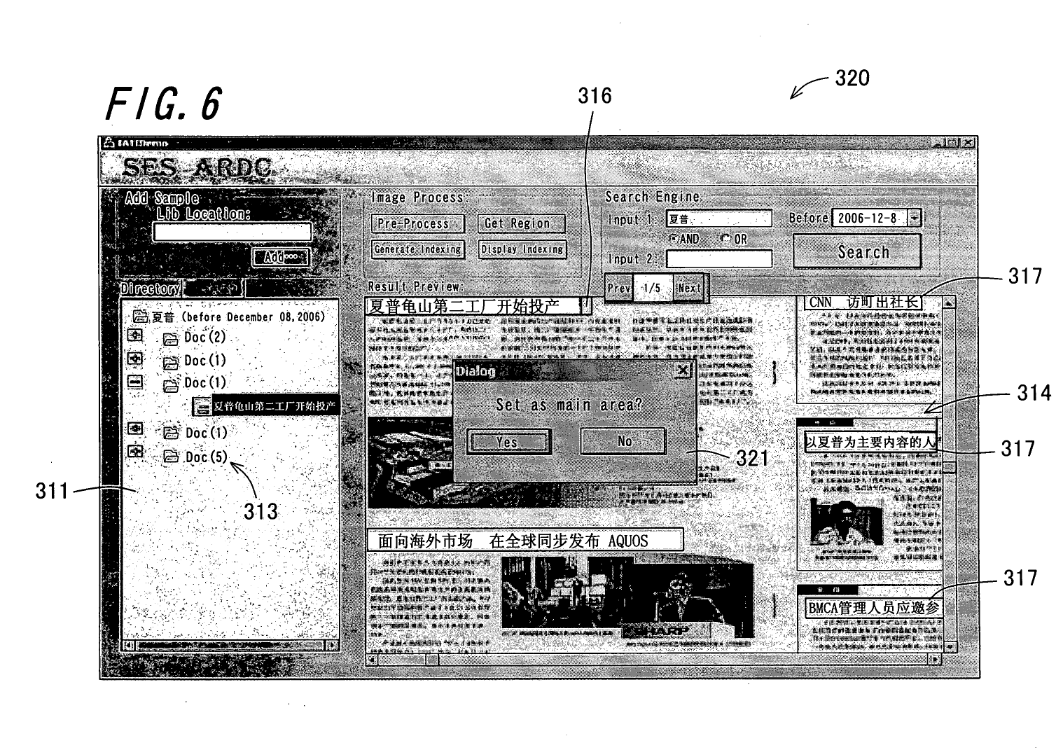

FIG. 6 is a view showing one example of a display screen 320 ready for modifying the setting of the order. When one of the sub regions 317 is selected on the above-described display screen 310 shown in FIG. 4, a dialog box 321 is displayed. The dialog box 321 is used to designate whether or not the one selected sub region is set as a main region.

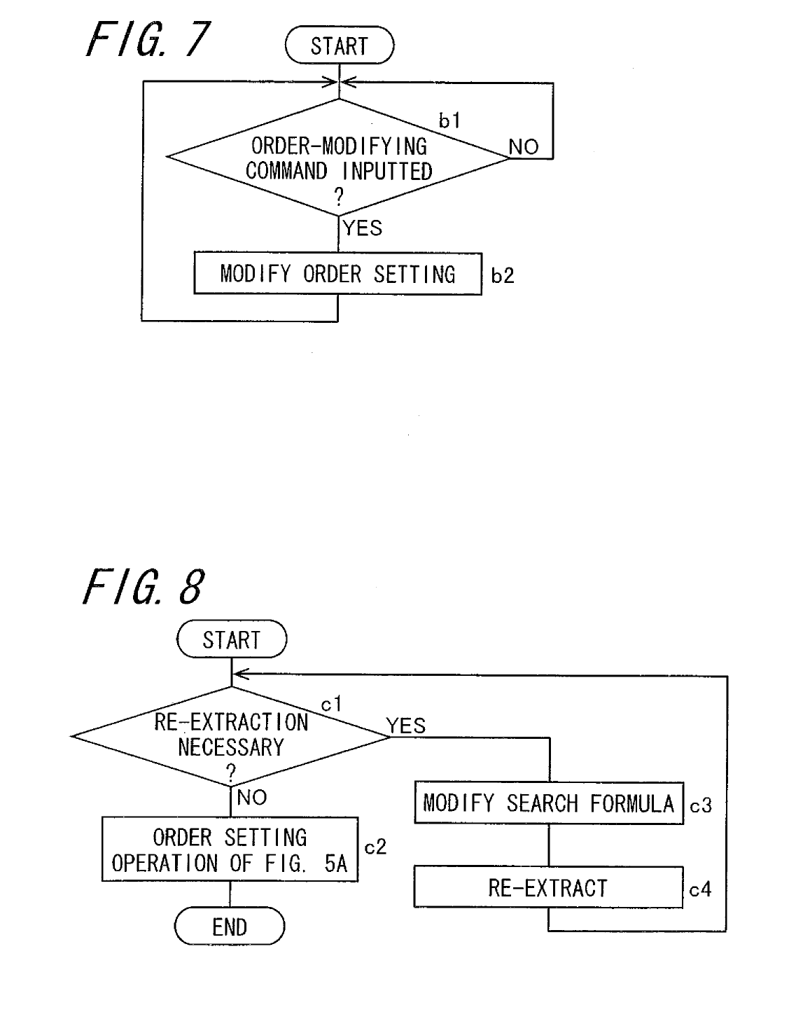

FIG. 7 is a flowchart of assistance in explaining an order modifying operation of the order setting portion 302. The order modifying operation of the order setting portion 302 is initiated when the order of the extracted heading region is set.

After the order-modifying operation has started, the order setting portion 302 determines in Step b1 whether or not an order-modifying command has been inputted into the order-modifying command inputting portion 304. The order-modifying command is inputted into the order-modifying command inputting portion 304 when the one selected sub region is set as a main region by using the dialog box 321 shown in FIG. 6.

Until the order-modifying command is inputted, the operation of Step b1 is repeatedly carried out. The determination that the order-modifying command has been inputted will bring the process to Step b2. In Step b2, the setting of the order of the heading region is modified in accordance with the inputted order-modifying command. To be specific, the order of one selected sub region is brought to the top, and such one sub region is set as a main region. And a region which used to be a main region until the change of setting is brought to the second place and set as a sub region. Further, the order of the remaining heading region is shifted appropriately. After the orders of all the heading regions have been modified, the process goes back to Step b1.

As described above, the order setting portion 302 modifies the setting of the order of the heading region extracted by the heading region extracting portion 301, in accordance with the inputted order-modifying command. The order can be thus reset according to need, and adaptability can be enhanced concerning the setting of the order.

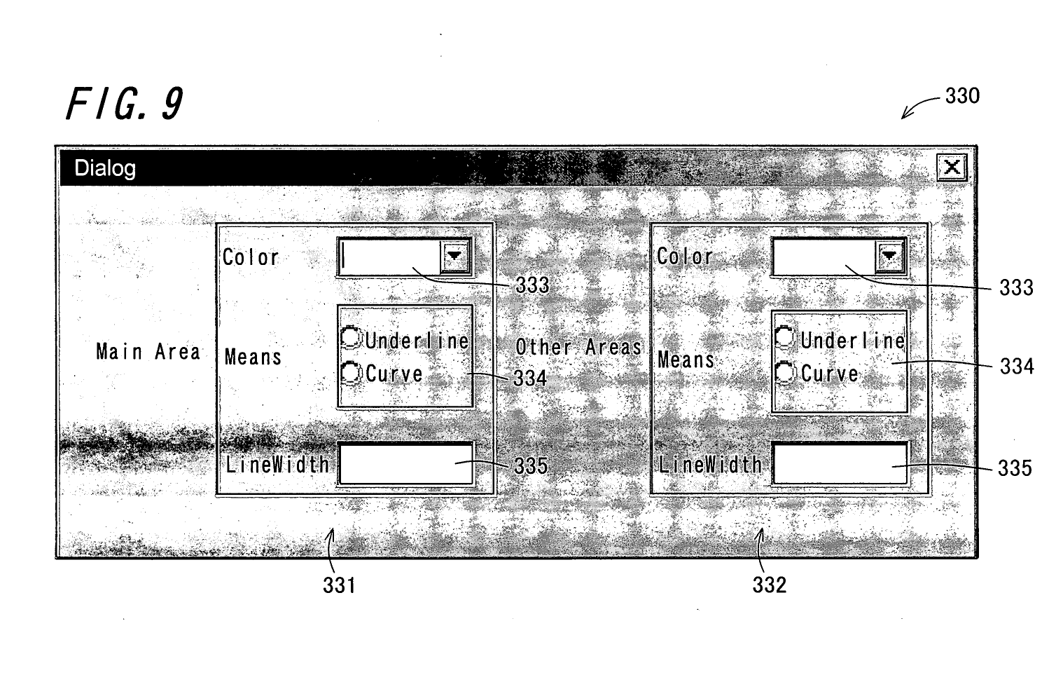

FIG. 8 is a flowchart of assistance in explaining the fourth example of the order setting operation of the order setting portion 302. The order setting operation of the fourth example is similar to the order setting operation of the first example. Accordingly, in the following descriptions of the order setting operation of the fourth example, some points which are the same as those of the first example will be omitted. In the fourth example, the order setting portion 302 initiates the order setting operation in the same manner as in the case of the first example.

After the order setting operation has started, the order setting portion 302 determines in Step c1 whether or not the heading region needs to be extracted again. To be specific, the order setting portion 302 determines whether or not the number of the extracted heading region falls in a predetermined range. In other words, when the number of the extracted heading region is too large and too small, the order setting portion 302 determines that the re-extraction is necessary. When the re-extraction is necessary, the process goes to Step c2. When the re-extraction is not necessary, the process goes to Step c3.

In Step c2, the order setting operation of the first example shown in FIG. 5A is carried out. In Step c3, the search formula is modified. Next, in Step c4, the search formula modified in Step c3 is used to re-extract the heading region. The process then goes back to Step c1.

The order setting operation as described above is carried out and the adequate number of heading regions are thereby highlighted. This also enables to reduce the troubles of finding the desired heading from the document image.

A constitution may be adopted that the above determination of Step c1 is conducted by a user. Even in such a case, it is possible to reduce the troubles of finding the desired heading from the document image.

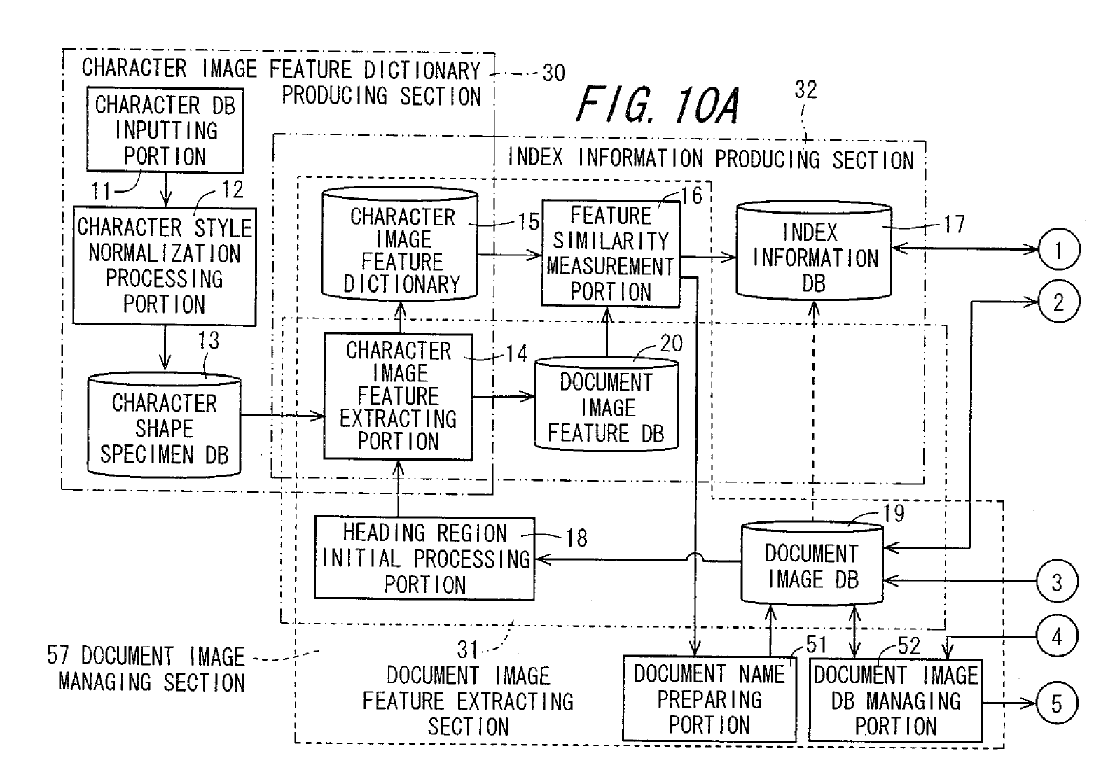

FIG. 9 is a view showing one example of a dialog box 330 for modifying a display mode of highlight. The dialog box 330 has a main region setting region 331 for setting a display mode of a main region, and a sub region setting region 332 for setting a display mode of a sub region. The main region setting region 331 is located on a left side in the dialog box 339 while the sub region setting region 332 is located on a right side in the dialog box 330.

A constitution of the main region setting region 331 and a constitution of the sub region setting region 332 are similar to each other and therefore, corresponding parts will be denoted by the same reference numerals. Only the constitution of the main region setting region 331 will be described while descriptions of the constitution of the sub region setting region 332 will be omitted. The main region setting region 331 has a region 333 for selecting a color of line, a region 334 for selecting a type of line, and a region 335 for selecting a width of line. In the one example shown in FIG. 9, either one of a straight underline and a wavy line is selected as the type of line. The dialog box 330 as just described is used to set the display mode of the main region and the display mode of the sub region.

As described above, the displaying portion 303 can set the display mode of highlight, with the result that a demand for individualization can be satisfied.

FIGS. 10A and 10B are block diagrams showing in detail the constitution of the document image processing apparatus 10. The document image processing apparatus 10 includes a character database inputting portion (character DB inputting portion) 11, a character style normalization processing portion 12, the character shape specimen DB 13, a character image feature extracting portion (image feature extracting portion) 14, the character image feature dictionary 15, a feature similarity measurement portion 16, the index information DB 17, a heading region initial processing portion 18, the document image DB 19, a document image feature database (document image feature DB) 20, a document image inputting portion 21, a searching section 22, a lexical analyzing section 23, a keyword inputting portion 24, a search result displaying portion 25, a document name preparing portion 51, a document image DB managing portion 52, a document image displaying portion 53, and an instruction inputting portion 54.

Among the components listed above, the character DB inputting portion 11, the character style normalization processing portion 12, the character shape specimen DB 13, the character image feature extracting portion 14, and the character image feature dictionary 15 constitute a character image feature dictionary producing section 30 which performs the aforementioned character image feature dictionary preparing process.

Firstly, descriptions are given to the aforementioned functional blocks 11, 12, 13, 14, and 15 which constitute the character image feature dictionary producing section 30.

The character DB inputting portion 11 is used for inputting a fundamental character database which is necessary for preparing the character image feature dictionary 15. When the present apparatus is adaptable to, for example, Chinese, 6763 characters in the GB2312 of People's Republic of China, and the like element are all inputted to the character DB inputting portion 11. In addition, when the present apparatus is adaptable to Japanese, approximately 3000 characters of JIS level-1, and the like element are inputted to the character DB inputting portion 11. That is to say, the characters mentioned herein include symbols. The character DB inputting portion 11 as has been described heretofore is constructed by the processor 4. The character database is provided via a recording medium or across a network, or the like.

The character style normalization portion 12 is designed to prepare character images different in font and size, of all the characters included in the character database inputted by the character DB inputting portion 11. The character images different in font and size are stored in the character shape specimen DB 13.

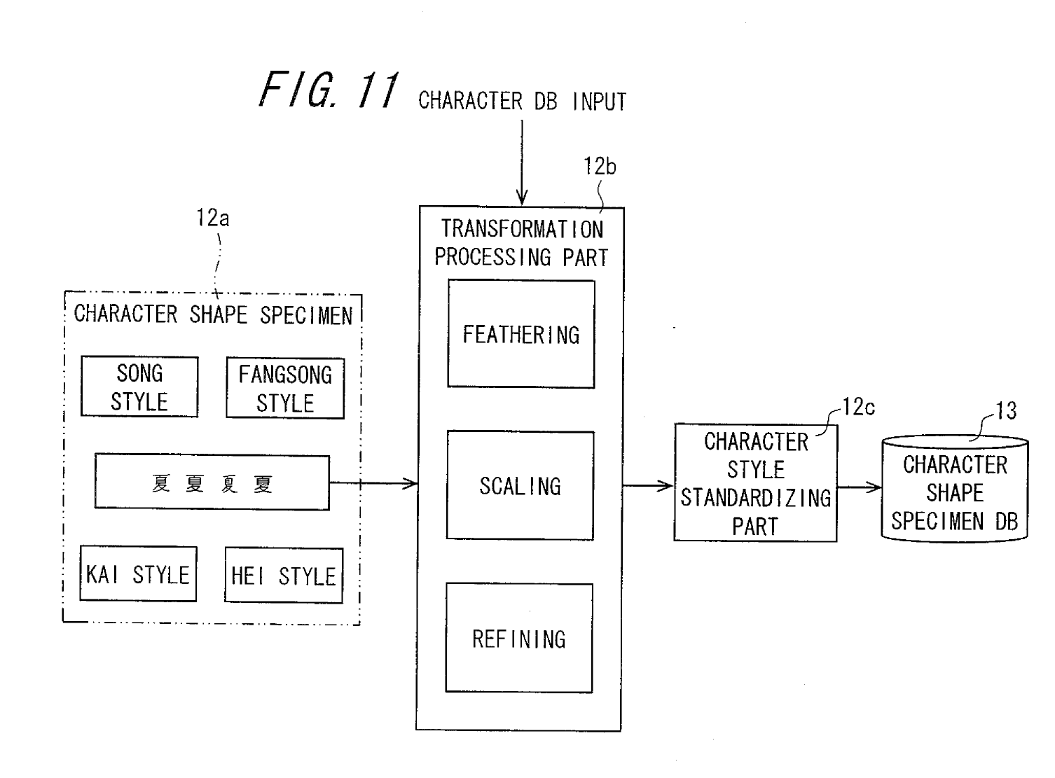

FIG. 11 shows a process on how the character style normalization processing portion 12 prepares the character shape specimen DB 13. When the present apparatus is adaptable to Chinese, the character style normalization processing portion 12 is provided with, for example, a character shape specimen 12a such as Song style, Fangsong style, Hei style, and Kai style. In addition, when the present apparatus is adaptable to Japanese, the character style normalization processing portion 12 is provided with, for example, a character shape specimen such as MS Ming-cho style and MS Gothic style.

The character style normalization processing portion 12 includes a character shape specimen 12a, a transformation processing part 12b, and a character style standardizing part 12c. The transformation processing part 12b images the characters in the character database and standardizes resulting character images. Next, in reference to the character shape specimen 12a, the transformation processing part 12b performs a transformation process on the standardized character images and further prepares character images different in font and size. The transformation process includes a feathering process, a scaling process, and a refining process. The character images already treated with the transformation process as mentioned above are brought by the character style standardizing part 12c to the character shape specimen DB 13 where the character images are then stored as reference character images.

In the character shape specimen DB 13, the reference character images of all the characters in the character database are stored in units of character shape which is defined by font and size even for one identical character. To cite a case, even for one character [symbol] in the character type, the character shape specimen DB 13 stores as many the reference character images [symbol] different in shape as the predetermined number of the font. In addition, the character shape specimen DB 13 also stores as many the reference character images [symbol] different in size as the predetermined number of the size.

The character image feature extracting portion 14 extracts features of character image (abbreviated as the “image features”) and stores the extracted features in the character image feature dictionary 15 where the extracted features are then stored. In the present embodiment, the character image feature extracting portion 14 extracts the features of character image by combining character image peripheral features and grid-direction-wise features. The extracted features of character image are adopted as feature vectors. Note that the features of character image are not limited to the feature just described, and other features may be extracted to be feature vectors.

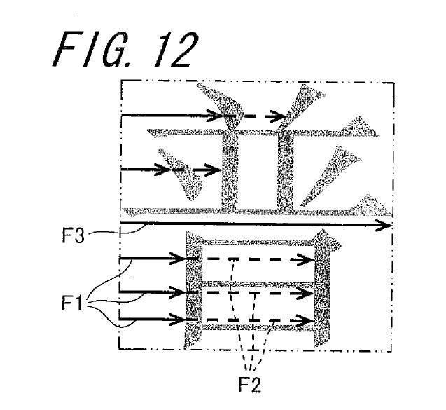

Here, descriptions will be given to the character image peripheral features and the grid-direction-wise feature. FIG. 12 is an illustration of the character image peripheral features. The character image peripheral features refer to outline features viewed from without. As shown in FIG. 12, scanning from four sides of a circumscribing rectangle of the character image, a distance from the four sides thereof to a border point between a white pixel to a black pixel is defined as a feature. A position of the first change of the pixel color and a position of the second change of the pixel color are taken out.

For example, the circumscribing rectangle is divided into X rows and Y columns. In this case, the image is subjected to leftward scanning and rightward scanning respectively row by row and is subjected to upward scanning and downward scanning respectively column by column. Note that FIG. 12 shows a diagram where the image is subjected to leftward scanning row by row.

In FIG. 12, a solid arrow F1 indicates a scanning path to the point of the first change of pixel color from white to black. A dashed arrow F2 indicates a scanning path extending to the point of the second change of pixel color from white to black. A solid arrow F3 indicates a scanning path through which no points of pixel color change from white to black are detected. In this case, the distance value is zero.

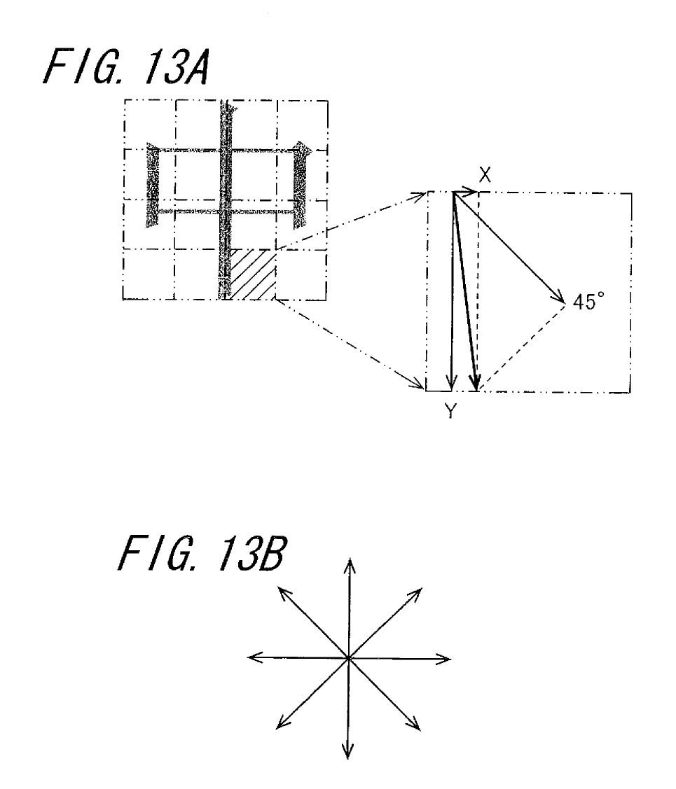

FIG. 13A and FIG. 13B are illustrations of the grid-direction-wise features. A character image is divided in a rough grid pattern. An attempt is made in a plurality of predetermined directions to detect black pixels in the respective grids. A number of black pixels which are connected in each of the directions is counted, and direction contributing degrees which represent a distribution state of the black pixels with respect to each of the direction components thereof is calculated by dividing distance values by a value corresponding to a difference in number of black pixels using Euclidean distance as a discrimination function.

In FIG. 13A, the character image is divided into 16 grids in a 4×4 grid pattern, and black pixels are attempted to be detected in three directions of X-axis direction (0°), a 45-degree direction, and a Y-axis direction (90°) from a center point, i.e., a point of change of pixel color form black to white, which point is located at the shortest distance in the X-axis direction from a grid intersection.

In the present embodiment, the character image is divided in an 8×8 square mesh pattern. As shown in FIG. 13B, black pixels are attempted to be detected in eight directions, namely, a 0-degree direction, a 45-degree direction, a 90-degree direction, a 135-degree direction, a 180-degree direction, a 225-degree direction, a 270-degree direction, and a 315-degree direction.

Note that grid-direction-wise feature extracting methods may be various with different directions in which black pixels are attempted to be detected or with different positions of the center point about which black pixels are attempted to be detected. For example, refer to the descriptions in Japanese Unexamined Patent Publication JP-A 2000-181994.

The character image feature extracting portion 14 carries out the extraction of feature of character image as just described, on all the reference character images stored in the character shape specimen DB 13. And the character image feature extracting portion 14 stores an extraction result of the reference character image stored in the character shape specimen DB 13 in the character image feature dictionary 15 where the extraction result is then stored, thus producing the character image feature dictionary 15.

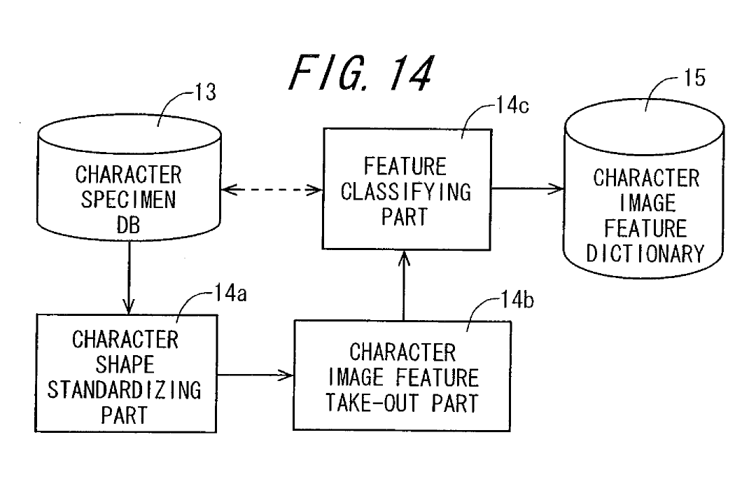

FIG. 14 shows a process on how the character image feature extracting portion 14 prepares the character image feature dictionary 15. In the character image feature extracting portion 14, a character shape standardizing part 14a takes out a reference character image from the character shape specimen DB 13, and a character image feature take-out part 14b takes out features of the reference character image taken out by the character shape standardizing part 14a. And then, in reference to the character shape specimen DB 13, a feature classifying part 14c classifies the features extracted in units of reference character image, and stores the classified features in the character image feature dictionary 15 where the classified features are then stored.

As has been described heretofore, the character image feature take-out part 14b determines a feature adaptive value of the differently-weighted reference character images in units of single character and acquires a standard feature of the reference character images.

The character image feature take-out part 14b can prepare various character image feature dictionaries by weighting different character styles and character sizes. The image features of multi-font characters are combined with each other to form features of single character image which are used to prepare a character image feature dictionary. This enables to satisfy automatic index and management of a document image composed of multi-font and/or multi-size characters.

Next, descriptions will be given to the document image DB 19, the document image feature DB 20, the heading region initial processing portion 18, and the character image feature extracting portion 14, which constitute a document image feature extracting section 31 for performing the document image feature extracting process.

The document image DB 19 is used to assign a document ID for identification to a document image inputted by the document image inputting portion 21 and store the document image with the document ID.

After a new document image is stored in the document image DB 19, the heading region initial processing portion 18 is used to locate a heading region of the document image according to the image data thereof, clip the heading region, and send character images thereof to the aforementioned character image feature extracting portion 14.

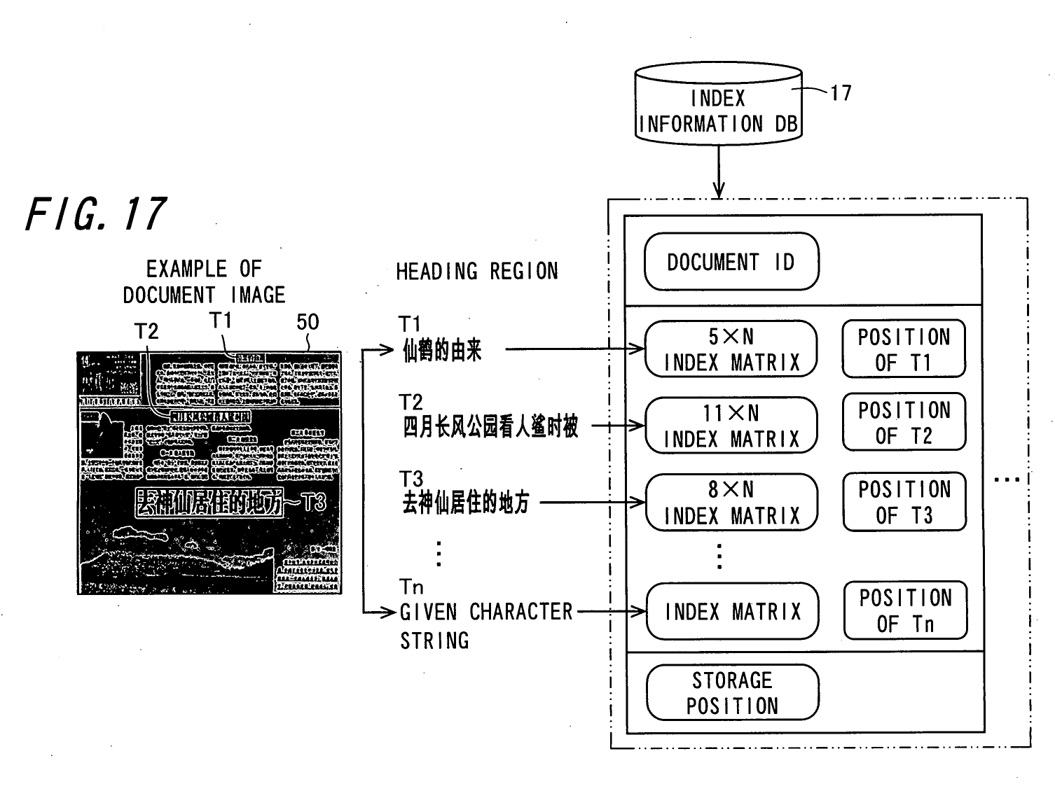

FIG. 17 shows a state where three heading regions T1, T2, and T3 have been located in a document image 50. As will be appreciated from FIG. 17, title parts of the document image 50 are clipped as heading regions T.

The character images which are clipped by the heading region initial processing portion 18 and thereafter sent to the character image feature extracting portion 14, are generally images of character string including a plurality of characters. Accordingly, the following descriptions will be based on that the character images sent by the heading region initial processing portion 18 are the images of character string.

In the present embodiment, the heading region initial processing portion 18 locates the heading regions and clips the heading regions by means of a projection method and a statistical analysis of communicating area. Note that the heading regions T as mentioned above often correspond to tile parts. Various existing methods can be applied to locate and clip the heading regions, for example, the methods described in the Japanese Unexamined Patent Publications JP-A 9-319747 (1997) and JP-A 8-153110 (1996).

As has been described above, only the heading regions T are located and clipped, without covering the whole character region (text region) of a document image. This enables a reduction in an amount of information to be searched, thereby shortening searching time.

Locating only the heading regions T, not the whole text region, is however not an essential constituent factor from the aspect of searching, and the whole text region may be located and clipped. Locating only the heading regions T is, on the other hand, an essential constituent factor from the aspect of preparing meaningful document names which will be described later on.

The character image feature extracting portion 14 divides the images of character string inputted from the heading region initial processing portion 18 into respective character images of single character. After that, the character image feature extracting portion 14 extracts features of each character image, as in the case of preparing the character image feature dictionary 15. Subsequently, the extracted features are stored, for every document image, in the document image feature DB 20.

The document image feature DB 20 stores image feature information of character string included in the heading regions T which have been clipped by the heading region initial processing portion 18, as a feature (feature vector) of each of characters constituting the character string.

As shown in FIG. 17, with respect to one document image 50, the document image feature DB 20 stores, together with the document ID of the document image 50, the character image features of character strings included in all the clipped heading regions T1, T2, T3 . . . , or the character image features of the respective characters constituting the character strings.

Next, descriptions will be given to the character image feature extracting portion 14, the character image feature dictionary 15, the feature similarity measurement portion 16, the index information DB 17, and the document image feature DB 20 which constitute an index information producing section 32 for performing an index information preparing process.

The functions of the character image feature extracting portion 14, character image feature dictionary 15, and document image feature DB 20 are as already described above.

The feature similarity measurement portion 16 reads out features, from the document image feature DB 20 of the character images included in the heading regions T of document image. On the basis of the read-out features, the feature similarity measurement portion 16 prepares, in reference to the character image feature dictionary 15, an index matrix as mentioned later, thereby producing index information of document image.

In this case, the index information is produced for each of document images, and the index matrix included in the index information is prepared for each of heading regions T. Accordingly, when one document image includes a plurality of heading regions T, a plurality of index matrices will be included in the index information of the document image.

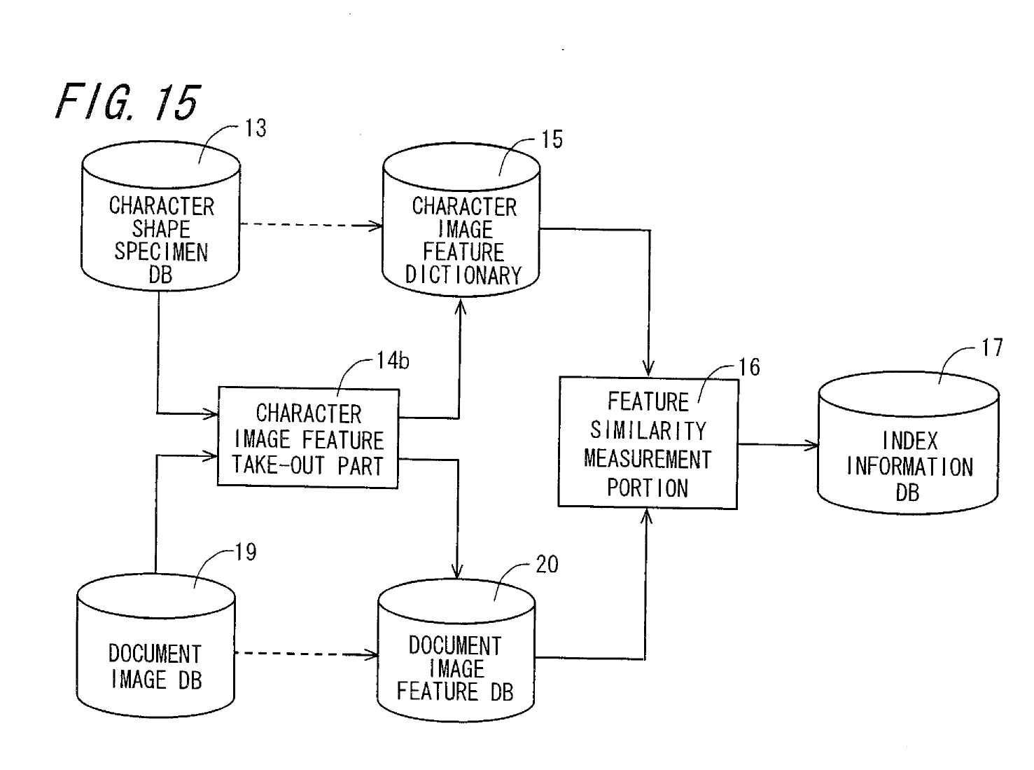

FIG. 15 shows a process on how to prepare the index information DB 17. As mentioned above, after a certain document image is inputted and stored in the document image DB 19, the character image feature extracting part 14b extracts character image features of a character string included in each of heading regions T and stores the extracted features in the document image feature DB 20 where the extracted feature is then stored.

The feature similarity measurement portion 16 reads out from the document image feature DB 20 the image features of the character string included in each of reading regions T. And then, the feature similarity measurement portion 16 carries out measuring similarity of the image of every single character with the reference character image included in the character image feature dictionary 15, thereby preparing an index matrix for each of heading regions T.

And then, the feature similarity measurement portion 16 forms index information by combining these index matrices with the other information of the document image, i.e., information such as the document ID and storage position of the document image in the document image DB 19. The feature similarity measurement portion 16 stores the index information in the index information DB 17 where the index information is then stored.

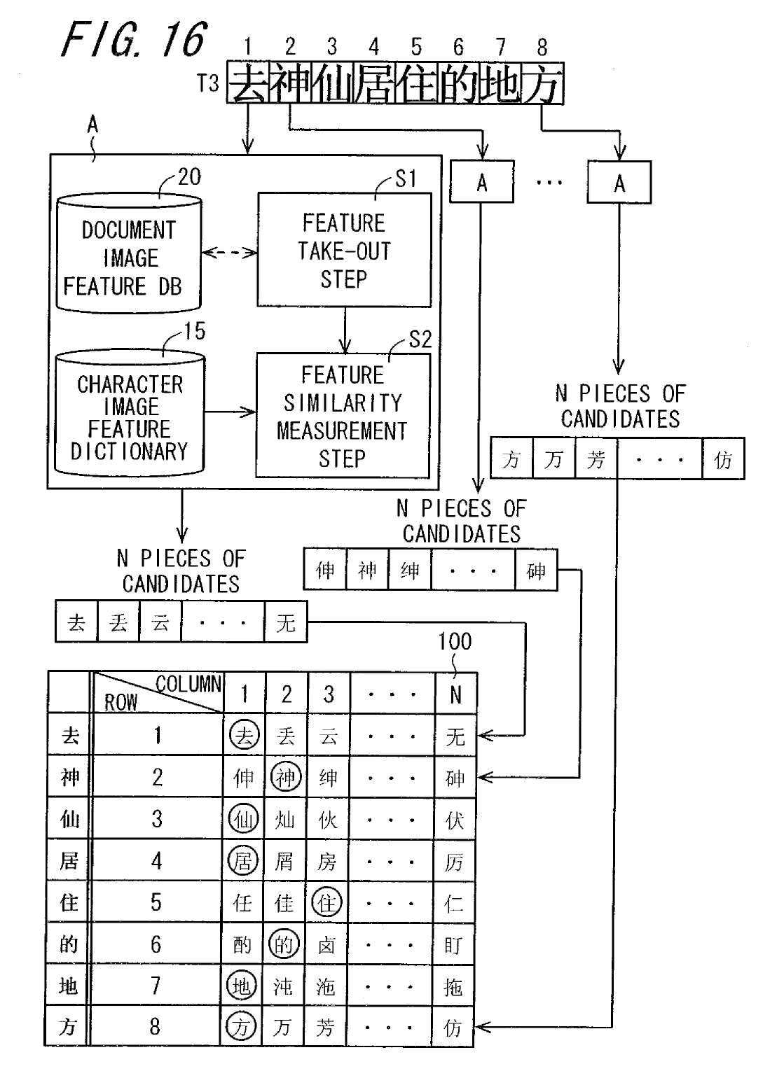

FIG. 16 shows one example of a process on how the feature similarity measurement portion 16 prepares the index matrix. FIG. 16 is an illustration on how to prepare an index matrix corresponding to eight character images of a character string [symbol] [symbol] included in the heading region T3 of FIG. 17.

The character string [symbol] [symbol] is divided into images of separate characters of [symbol] , [symbol] , [symbol] , [symbol] , [symbol] , [symbol] , [symbol] and [symbol] . For such a process of dividing the image of character string into the images of separate characters, a commonly-used existing method can be used.

Eight numbers from 1 to 8 are assigned to the eight characters of [symbol] , . . . , [symbol] according to an alignment order thereof, in such a manner that a number 1 is assigned to [symbol] , . . . , and a number 8 is assigned to [symbol] . The numbers here correspond to row numbers of the index matrix.

All of the above eight character images are subjected to a process comprising a feature take-out step (S1) and a feature similarity measurement step (S2) as indicated by a referential symbol A in FIG. 16. Step S1 is designed for taking out features of the character image [symbol] stored in the document image feature DB 20. Step S2 is designed for selecting N pieces of candidate characters in descending order of feature similarity (or in the descending order of degree of similarity) in reference to the character image feature dictionary 15.

Numbers corresponding to the extracting order are assigned to the N pieces of candidate characters extracted in descending order of degree of similarity. The numbers correspond to column numbers of the index matrix. A character correlation value (a correlation value) represents a degree of similarity between each of search characters included in a search keyword and candidate characters thereof. The correlation value is set according to the column numbers.

A table indicated by a reference numeral 100 in FIG. 16 shows the content of index matrix of the character string [symbol] [symbol] For example, for the character image of the fifth character [symbol] , candidate characters of [symbol] , [symbol] , [symbol] , . . . , [symbol] are extracted and positioned in Row 5 in descending order of degree of similarity. The character having the highest degree of similarity is positioned in the first column. In Table 100, the position of the candidate character [symbol] is represented as [1, 1], the position of the candidate character [symbol] is represented as [4, 2], and the position of the candidate character [symbol] is represented as [5, N].

Note that the candidate characters corresponding to the respective characters in the character string are circled in Table 100 of FIG. 16, to facilitate the understanding.

The row number M of the index matrix as has been described heretofore, is determined in accordance with the number of image character in the character string that is clipped as the heading region T by the heading region initial processing portion 18. In addition, the column number N is determined in accordance with the number of candidate characters selected in units of character. Consequently, according to the present invention, by changing the number of dimensions (the number of columns) of index matrix, it is possible to flexibly set the number of elements inside the index matrix or the number of candidate characters. This allows for a precise and substantially complete search in searching the document image.

A way on how the selected candidate character carries information in the index matrix can be appropriately set in accordance with a method of inputting the search keyword. For example, in the constitution that the keyword is inputted from the keyboard 1, the candidate characters are stored in form of information such as character codes, in such a manner that the search keyword inputted from the keyboard 1 can be targeted for searching.

In addition, in the constitution that the keyword is inputted in form of digital data by use of the image scanner 2 and the like, the candidate characters may be stored in form of feature (feature vector) information, in such a manner that the features (feature vectors) of the search keyword can be extracted and the extracted feature vectors can be compared with each other for searching.

FIG. 17 shows an example of data placement of index information in the index information DB 17. In index information of a document image 50 having a plurality of heading regions T1, T2, T3, . . . , Tn, index matrices are linearly-aligned that have been prepared with respect to the plurality of heading regions T1, T2, T3, . . . , Tn. In an example of FIG. 17, a document ID is placed on the top, followed by a plurality of the index matrices, and information of a storage position is placed on the bottom. Here, 5×N represents a size of the index matrix, which has five rows and N columns.

By placing the index information in the way as has been mentioned heretofore, it is possible to swiftly identify storage positions of document image and positions of heading region T of document image in the document image DB 19. The aforementioned identified position information can be used for displaying a search result.

Further, the index information contains position information of a plurality of the heading regions T1, T2, T3, . . . , Tn. The position information is utilized for analysis of position information in Step a5 and Step a9 in FIG. 5A described above, analysis of position information in Step a15 and Step a19 in FIG. 5B described above, and analysis of position information in Step a25 in FIG. 5C. Moreover, in response to a demand in practice, other attributes of the document image such as a size of the character image may be added to the index information.

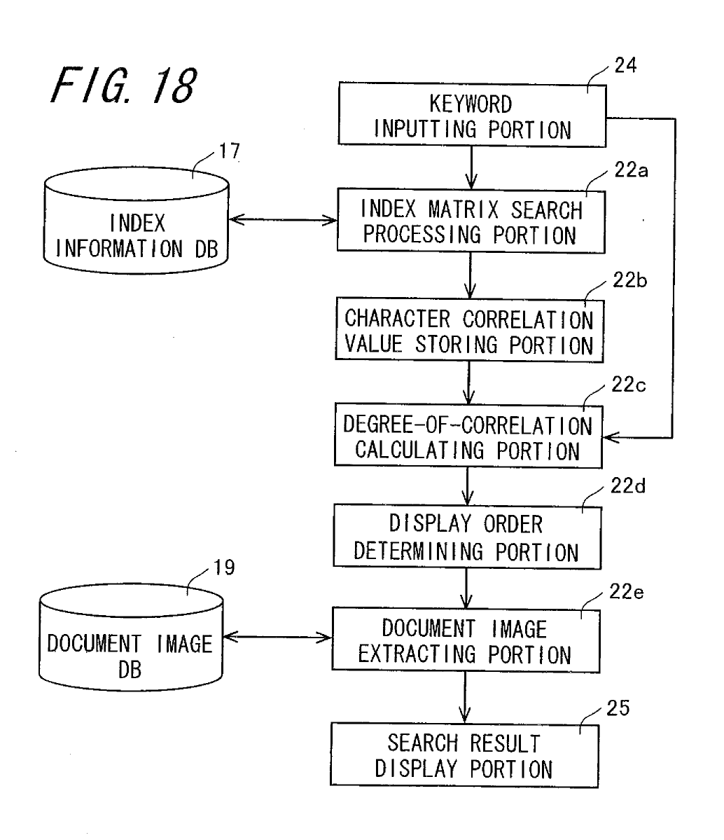

Next, descriptions will be given to a searching section 22, which performs a search process by use of the index information. FIG. 18 is an illustration showing functions and a search process of the searching section 22. The searching section 22 includes an index matrix search processing portion 22a, a character correlation value storing portion (storing portion) 22b, a degree-of-correlation calculating portion 22c, a display order determining portion (order determining portion) 22d, and a document image extracting portion 22e.

A search keyword is inputted from the keyword inputting portion 24 to the index matrix search processing portion 22a. An example of the keyword inputting portion 24 is the aforementioned keyboard 1 or the aforementioned image scanner 2, etc.

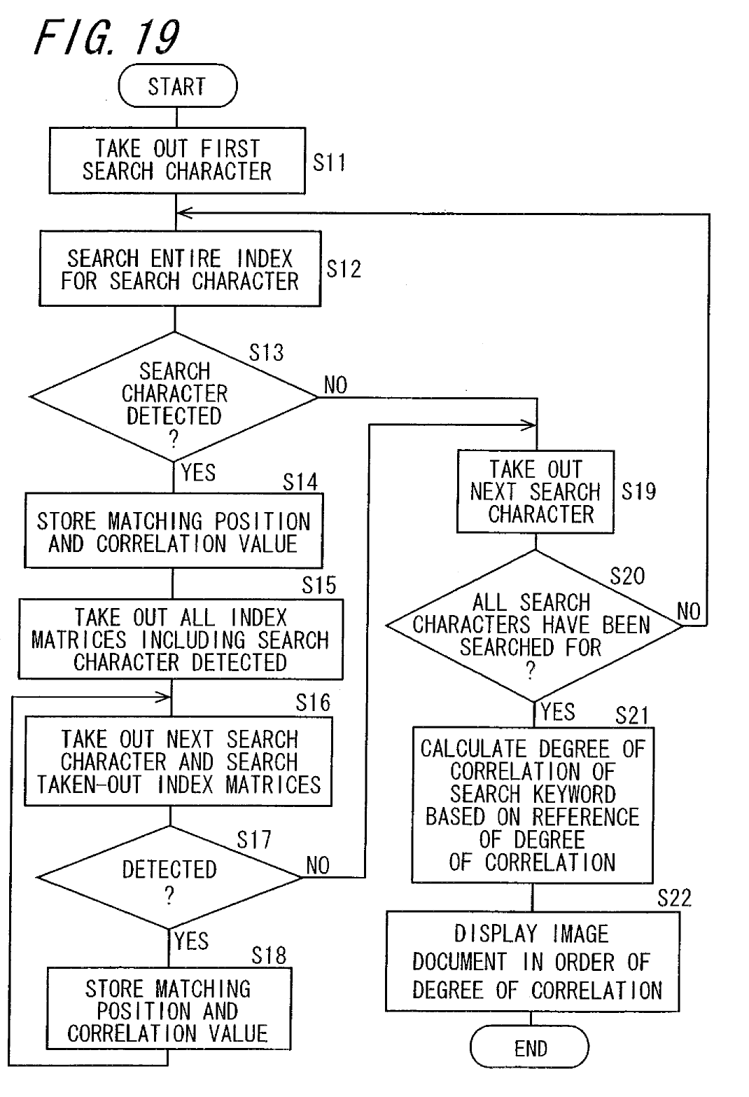

The index matrix search processing portion 22a searches the index information DB 17 so as to detect index matrices including the inputted search keyword. The index matrix search processing portion 22a divides the search keyword into separate search characters and searches for the index matrices including the respective search characters. In this way, when the search characters are included, the index matrix search processing portion 22a acquires matching position information in the index matrices of the search characters. Note that an example of procedure for extracting the index matrix will be described in reference to a flowchart in FIG. 19.

The character correlation value storing portion 22b stores the matching position information acquired by the index matrix search processing portion 22a, and also stores a character correlation value corresponding to the column number of matching position.

After the index matrix search processing portion 22a completes the detection of all the index matrices, the degree-of-correlation calculating portion 22c calculates a degree of correlation between the detected index matrix and the search keyword.

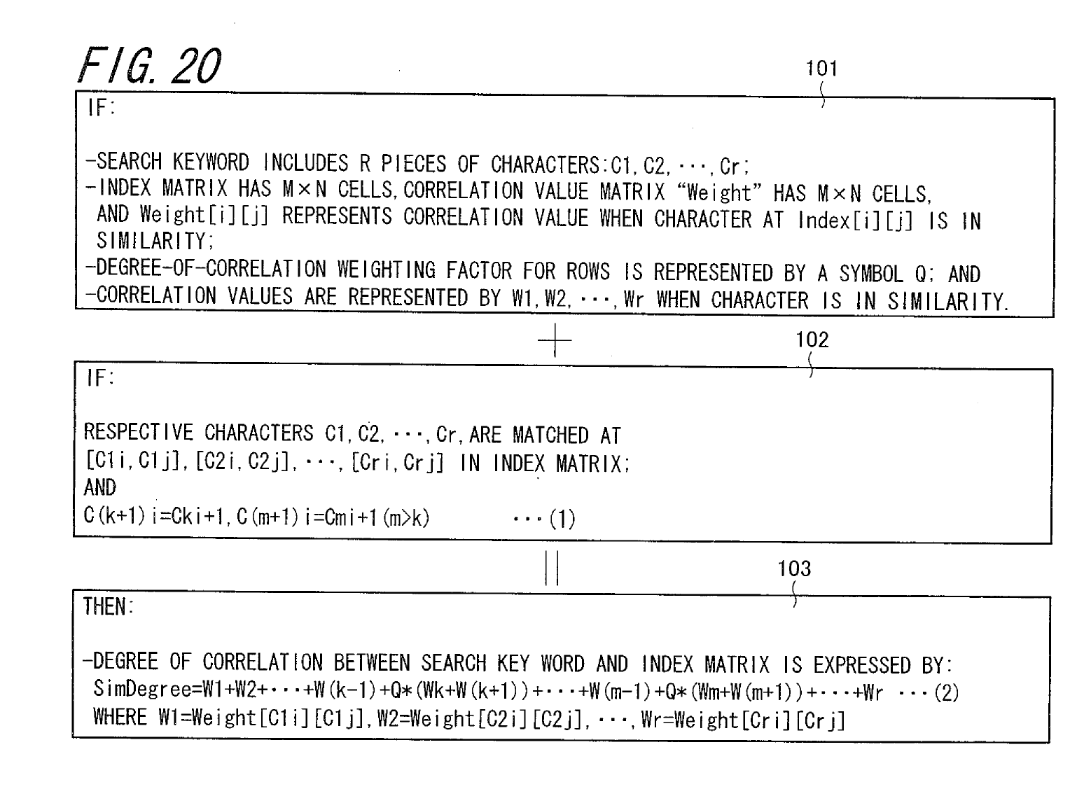

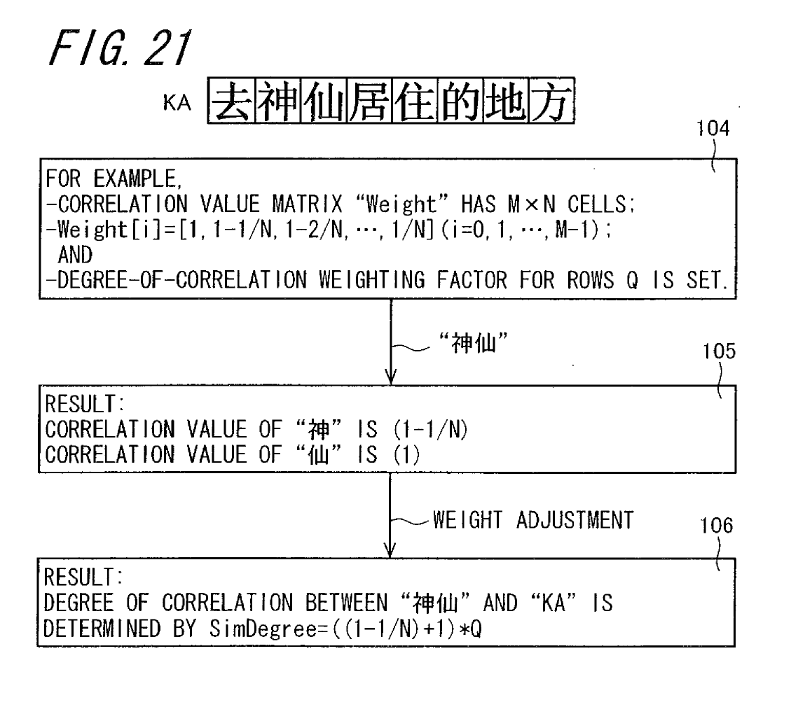

By means of a predetermined method for calculating the degree of correlation, the degree of correlation is calculated using the information of matching position and the information character correlation value stored in the character correlation value storing portion 22b. The calculation of the degree of correlation will be described in reference to FIGS. 20 and 21 later on.

Note that although the constitution employed herein has the character correlation value storing portion 22b which stores the matching position information and the character correlation value corresponding to the column number of the matching position, another constitution may be adopted such that the character correlation value storing portion 22b stores only the matching position information while the degree-of-correlation calculating portion 22c acquires the character correlation value corresponding to the matching position information.

The display order determining portion 22d determines a display order on the basis of the information of degree of correlation calculated by the degree-of-correlation calculating portion 22c. According to an order of document images which are arranged in descending order of degree of correlation of the index matrixes included therein, the display order determining portion 22d determines the display order in such a manner as to allow the content of document images to be displayed by the search result displaying portion 25.

The document image extracting portion 22e reads out image data of document image from the document image DB 19 and outputs the image data to the search result displaying portion 25 so that the document image is displayed on the search result displaying portion 25 in the order determined by the display order determining portion 22d.

The search result displaying portion 25 displays document images according to a display order. The document images may be displayed in thumbnailed form or the like. An example of the search result displaying portion 25 is the aforementioned display device 3 or the like device.

Now, the search procedure will be described. FIG. 19 is a flowchart showing the search procedure in the searching section 22. Step S11 is firstly performed when a search keyword composed of R pieces of character string is inputted and a searching instruction is given correspondingly. In Step S11, the index matrix search processing portion 22a extracts the first search character of the search keyword.

Next, the search procedure goes to Step S12. In Step S12, the index matrix search processing portion 22a searches for the first search character in all the index matrices of the index information DB 17.

When all the index matrices have been searched, it is determined whether or not the first search character has been detected. When the first search character has not been detected at all, the search procedure goes to Step S19. Contrarily, when the first search character has been detected, the search procedure goes to Step S14.

In Step S14, the index matrix search-processing portion 22a stores matching position information and character correlation values of the index matrices including the first search character, in the character correlation value storing portion 22b where the matching position information and character correlation values are then stored.

Subsequently, the search procedure goes to Step S15. In Step S15, the index matrix search processing portion 22a extracts all index matrices including the first search character. And then, in Step S16, the index matrix search processing portion 22a extracts another character of the search keyword, which serves as the second search character, and searches for the second search character in the index matrices including the first search character.

After all the index matrices extracted in Step S15 have been searched, the search procedure goes to Step S17. In Step S17, it is determined whether or not the second search character has been detected. When the second search character has not been detected at all, the search procedure goes to Step S19 as in the above case. Contrarily, when the second search character has been detected, the search procedure goes to Step S18.

In Step S18, the index matrix search processing portion 22a stores matching position information and character correlation values of the index matrices including the second search character, in the character correlation value storing portion 22b where the matching position information and character correlation values are then stored.

Next, back to Step S16 again, the index matrix search processing portion 22a extracts yet another character of the search keyword, which serves as the third search character. And further, the index matrix search processing portion 22a searches for the third search character in the index matrices including the first search character extracted in Step S15.

And then, similarly, when the aforementioned search has been completed, Step S17 is performed. In Step S17, the index matrix search processing portion 22a determines whether or not the third search character has been detected. When the third search character has not been detected at all, the search procedure goes to Step S19 as in the above case. Contrarily, when the third search character has been detected, the search procedure goes to Step S18. In this way, the aforementioned search process is performed with respect to yet another search character of the search keyword.

The process from Step S16 to Step S18 as has been described heretofore, refers to a search refinement for the second or following search character in the index matrices which include the first search character and thus extracted in Step S15. The index matrix search processing portion 22a performs the above process from Step S16 to Step S18 until such a determination is obtained in Step 17, that the search character has not been detected at all, or until such a determination is obtained that all the search characters in the search keyword have been searched for. The search procedure then goes to Step S19.

In Step 19, the index matrix search processing portion 22a takes out a next character in the search keyword, which serves as the second search character. Subsequently, in Step S20, it is determined whether or not the last search character has been searched for, that is, whether or not all the search characters have been subjected to the process from S16 to S19. When not all the search characters have been subjected to the process from S16 to S19, the search procedure goes back to Step S12.

And then, as have been mentioned heretofore, the index matrix search processing portion 22a searches for the second search character in all the index matrices in the index information DB 17. When the second search character is detected successfully, the matching position and the character correlation values of the index matrices are stored. Next, the procedure goes to Step S15. And the search refinement is performed by repeating Steps S16 to S18, through which next character of the search keyword, that is, the third or following characters coming after the second search character, are searched for in all the index matrices including the second search character.

The index matrix search processing unit 22a also performs the search process as has been described heretofore, sequentially for the third and following search characters. To be specific, in the search process, a next search character is extracted in Step S19, index matrices including the extracted search character are taken out, and the taken-out index matrices are subjected to the search refinement for a search character which follows the search character included in the index matrices.

After all the search characters in the search keyword have been taken out in Step S19, the search procedure goes to Step S20. When it is determined in Step S20 that all the search characters have been subjected to the search process as have described heretofore, the search procedure goes to Step S21.

In Step S21, according to a reference of degree of correlation, the degree-of-correlation calculating portion 22c calculates the correction degree between the search keyword and the respective index matrices in the way as will be described later on.

And then, the search procedure goes to Step S22. In Step S22, the display order determining portion 22d determines a display order. The display order is so determined as to enable the display to begin from the document image including an index matrix of a high degree of correlation. Moreover, in Step S22, the document image extracting portion 22e acquires image data of document image from the document image DB 19 and the search result displaying portion 25 displays the document images in descending order of degree of correlation thereof.

Subsequently, referring to FIGS. 20 and 21, descriptions will be given to the methods for calculating a degree of correlation between an index matrix and the search keyword in the degree-of-correlation calculating portion 22c, according to the reference of degree of correlation.

Search conditions are described in a block indicated by the reference numeral 101 in FIG. 20. For the sake of calculating the degree of correlation, a relative relationship is supposed between a certain search keyword and an index matrix. The relative relationship is described in the block indicated by the reference numeral 102. When the search keyword and the index matrix has the relative relationship as shown in the block 102 under the search conditions shown in a block 101, the degree of correlation between the search keyword and index matrix is calculated correspondingly according to a calculating formula as shown in a block 103.

Firstly, the search conditions in the block 101 are described. The number of characters in the keyword is set at R. The first search character is represented by C1, the second search character is C2, . . . , and the R-th search character is Cr.

An index matrix to be searched is a matrix of M×N cells. That is to say, the number of image characters is M in the character string clipped as the heading region T, and the number of candidate characters is N selected in units of character in the character string.

A character correlation value is defined as a correlation value between a search character and respective candidates thereof. The correlation value is set in accordance with respective positions of the index matrix. Consequently, the character correlation values form a matrix of the same cells as that of the index matrix. That is to say, a matrix Weight of character correlation value is a matrix of M×N cells. For example, Weight[i][j] represents a character correlation value, when a candidate character positioned at [i, j] (also represented by Index[i][j]) in the index matrix is found. In the present embodiment, as long as the column numbers [j] of the index matrix are the same, correlation values of character are the same, independently of row numbers [i].

When a search character is found in two adjacent rows in the index matrix, a degree-of-correlation weighting factor for rows Q is applied to a correlation value of characters in the two rows. When a search character is found in two adjacent rows, it is more likely to include two successively-positioned characters of the search keyword.

When the degree-of-correlation weighting factor for rows Q is set at a high value, a contribution to the degree of correlation calculated by the degree-of-correlation calculation portion 22c is high for the character correlation values of two rows successively in similarity and is low for the correlation values of nonadjacent respective rows becomes small. That is to say, when the degree-of-correlation weighting factor for rows Q is set at a high value, the search result is close correspondingly to the results obtained by searching for the whole vocabulary. Oppositely, when the degree-of-correlation weighting factor for rows Q is set at a low value, the search result is close to the results obtained by searching for the respective characters.

W1 represents the character correlation value corresponding to the search character C1, and W2 represents the character correlation value corresponding to the second search character C2, . . . , and Wr represents the character correlation value corresponding to the search character Cr.

Next, a description will be given to the supposed relative relationship between the search keyword and the index matrix shown in a block 102.

Between the search keyword and the index matrix, there exists a matching relationship between every search character C1, C2, . . . , Cr, and any one of the candidate characters in the index matrix. Matching positions of respective candidate characters matching the respective searching characters C1, C2, . . . , Cr are represented as [C1i, C1j], [C2i, C2j], . . . , [Cri, Crj].

Then, a further relative relationship is expressed by a formula (1) shown in the block 102, that is:

C(k+1)i=Cki+1, C(m+1)i=Cmi+1(m>k) (1)

where k and m represent relative positions of the respective search characters constituting the search keyword; C(k+1)i represents a row number of the index matrix of candidate characters which are in similarity with the (k+1)-th search character of the search keyword; and Cki represents a row number of the index matrix of candidate characters which are in similarity with the k-th search character of the search keyword.

Accordingly, C(k+1)i=Cki+1 represents that the row number in the index matrix of candidate characters which are in similarity with the (k+1)-th search character of the search keyword is identical to a 1-plus row number in the index matrix of candidate characters which are in similarity with the k-th search character of the search keyword. In other words, C(k+1)i=Cki+1 indicates the (k+1)-th search character and the k-th search character are in similarity in two adjacent rows in the index matrix, respectively.

The same goes for C(m+1)i=Cmi+1, which indicates the (m+1)-th search character and the m-th search character in the search keyword are found in two adjacent rows in the index matrix, respectively.

When the search keyword and the index matrix have the relative relationships as have been mentioned heretofore, the degree of correlation between the search keyword and the index matrix is calculated by a formula (2) shown in the block 103. The formula 2 is expressed by:

$$SimDegree = W 1 + W 2 + … + W ( k - 1 ) + Q * ( Wk + W ( k + 1 ) ) + … + W ( m - 1 ) + Q * ( Wm + W ( m + 1 ) ) + … + Wr \qquad ( 2 )$$

where W1 represents a character correlation value corresponding to the first search character C1, W2 represents a character correlation value corresponding to the second search character C2, and W(k−1) represents a character correlation value corresponding to the (k−1)th search character C(k−1). Similarly, W(k) represents a character correlation value corresponding to the k-th search character Ck, and W(k+1) represents a character correlation value corresponding to the (k+1)-th search character C(k+1). In addition, W(m−1) represents a character correlation value corresponding to the (m−1)-th search character C(m−1). In the same way, W(m) represents a character correlation value corresponding to the m-th search character Cm, and the W(m+1) represents a character correlation value corresponding to the (m+1)-th search character C(m+1). Then, Wr represents a character correlation value corresponding to the r-th search character Cr.

In this way, the correlation value is calculated by accumulating the correlation values of all the search characters constituting the search keyword.

The k-th search character Ck and the (k+1)-th search character C(k+1) are found in two adjacent rows in the index matrix, respectively. Then, Q*(Wk+W(k+1)) in the formula (2) represents that the sum of the character correlation value Wk and the character correlation value W(k+1) is multiplied by the degree-of-correlation weighting factor for rows Q. It is the same in the case of Q*(Wm+W(m+1)).

Note that the (k−1)-th search character and the k-th search character are not found in two adjacent rows, and therefore both W(k−1) and Wk are not multiplied by the degree-of-correlation weighting factor for rows Q. It is the same in the case of W(m−1) and Wm.

In FIG. 20, however, the character correlation values of all the search characters from W1 to Wr are accumulated in the formula (2) because the search keyword and the index matrix shown in the block 102 are supposed to have such a relative relationship that every search characters C1, C2, . . . , Cr is in similarity with any one of candidate characters in the index matrix.

This is only one example and therefore, in the case where, for example, the search character C1 and the search character Cr have the relative relationship of formula (1) but are not in similarity with any candidate in the index matrix, the degree of correlation is calculated by the following formula:

$$SimDegree = W 2 + … + W ( k - 1 ) + Q * ( Wk + W ( k + 1 ) ) + … + W ( m - 1 ) + Q * ( Wm + W ( m + 1 ) ) + … + W ( r - 1 )$$

which formula has less cumulative terms, naturally resulting in a decreased degree of correlation.

Further, in the case where every character C1, C2, . . . , Cr is in similarity with any one of candidate characters in index matrix, and the (k+1)-th search character and the k-th search character of the search keyword, as well as the (k+2)-th search character and the (k+1)-th search character, are found in the adjacent two rows, respectively, the degree of correlation is calculated by the following formula:

$$SimDegree = W 1 + W 2 + … + W ( k - 1 ) + Q * ( Wk + W ( k + 1 ) + W ( k + 2 ) ) … + WR$$

In this case, the (k−1)-th search character and the k-th search character of the search keyword are not found in two adjacent rows. Therefore, both W(k−1) and Wk are not multiplied by the degree-of-correlation weighting factor for rows Q.

Next, a specific example is described on how to calculate the degree of correlation in reference to FIG. 21. Here, a degree of correlation is determined between the search keyword [symbol] and the index matrix (refer to Table 100) of the character string [symbol] [symbol] shown in FIG. 16.

Search conditions are shown in a block 104 of FIG. 21. Correlation value matrix Weight has M×N cells. The character correlation value is represented by Weight[i]=[1, 1−1/N, 1−2/N, . . . , 1/N] (i=0, 1, . . . , M−1). A degree-of-correlation weighting factor is represented by a symbol Q.

The search keyword [symbol] is divided into the first search character [symbol] and the second search character [symbol] For each of the search characters, an index matrix is searched for a corresponding candidate character.

As will be known in reference to Table 100 in FIG. 16, the search character of [symbol] corresponds to [2, 2] and the search character of [symbol] corresponds to [3, 1] in positions [i, j] of the index matrix.

Accordingly, as shown in a block 105, the character correlation value of the search character [symbol] is (1−1/N), and the character correlation value of the search character [symbol] is 1.

The row number of the search character [symbol] is “2”, and the row number of the search character [symbol] is “3”. As shown in Table 100 of FIG. 16, the two search characters are found in two adjacent rows in the index matrix, respectively.

Accordingly, as shown in a block 106, the character correlation value (1−1/N) of the search character [symbol] and the character correlation value 1 of the search character [symbol] are multiplied by the degree-of-correlation weighting factor for rows Q. The degree of correlation between the search keyword [symbol] and the index matrix of the character string [symbol] [symbol] is thus determined by SimDegree=Q*((1−1/N)+1).

In the formula for determining the degree of correlation between search keyword and index matrix, parameters such as the weight (character correlation value) of the correlation value matrix and the degree-of-correlation weighting factor for rows Q can be adjusted in accordance with the user's requirements. Consequently, this enables a more ideal search result to be obtained.

By use of the keyboard 1 and the like, the user can, according to his requirements, set appropriately the parameters such as the weight (character correlation value) of the correlation value index and the degree-of-correlation weighting factor for rows Q.

In the index and the similarity measurement method according to image features as have been mentioned heretofore, index and search of multilingual document images can be satisfied and no character recognition is performed with reduced computational effort. The present invention can be applied to document images of not only Chinese but also various other languages.

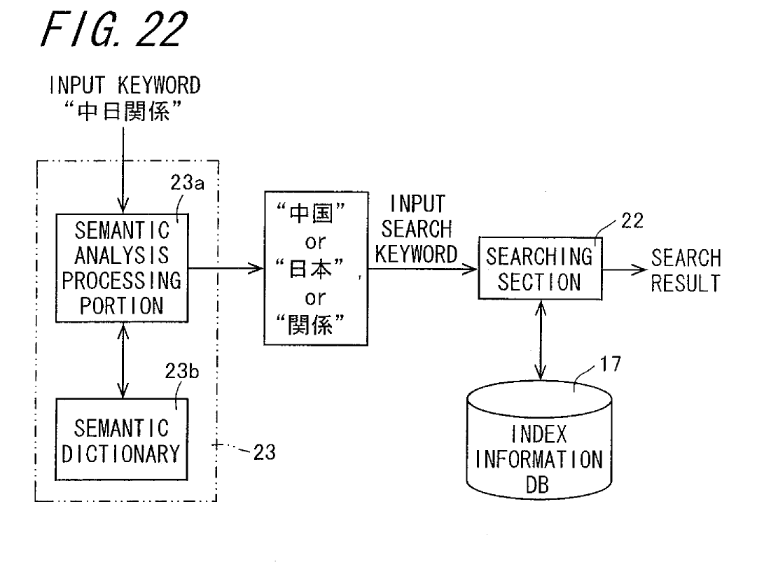

Subsequently, a description will be given to a search process having a lexical analysis function (a semantic analysis function). As also shown in FIG. 10B, in the document image processing apparatus 10 of the present embodiment, a lexical analyzing section 23 is provided between the keyword inputting portion 24 and the searching section 22. FIG. 22 shows a search process provided with the lexical analysis function.

The lexical analyzing section 23 is constructed of a semantic analysis processing portion 23a and a semantic dictionary 23b. When a search keyword is inputted from the keyword inputting portion 24, the semantic analysis processing portion 23a analyzes the meaning of the search keyword in reference to the semantic dictionary 23b.

For example, when [symbol] is inputted as the search keyword, the semantic analysis processing portion 23a inputs to the searching section 22 three words relating to [symbol] namely [symbol] [symbol] and [symbol] The words [symbol] [symbol] and [symbol] are treated respectively, so that [symbol] or [symbol] or [symbol] is targeted as a search formula.

When the search formula, namely [symbol] or [symbol] , or [symbol] , is inputted to the searching section 22, the searching section 22 searches the index information DB 17 and extracts document images including [symbol] , document images including [symbol] , or document images including

[symbol]

[symbol]

By doing so, not only document images including the search keyword but also document images related to the search word can be retrieved.

Next, a description will be given to the document image managing section 57 which performs a document image managing process. The document image managing section 57 is constructed of the character image feature extracting portion 14, the character image feature dictionary 15, the feature similarity measurement portion 16, the heading region initial processing portion 18, the document image DB 19, the document image feature DB 20, the document name preparing portion 51, the document image DB managing portion 52, the document image displaying portion 53, and the instruction inputting portion 54. Hereinbelow, the constituent portions constituting the document image managing section 57 will be described.

The description have already made on the functions of the character image feature extracting portion 14, the character image feature dictionary 15, the feature similarity measurement portion 16, the heading region initial processing portion 18, the document image DE 19, and the document image feature DB 20. Here, a description will be only given accordingly to the additional functions required for performing the document image managing process. Specifically, the document image managing process refers to preparing a meaning document name so as to mange the document images in the document image feature DB 20.

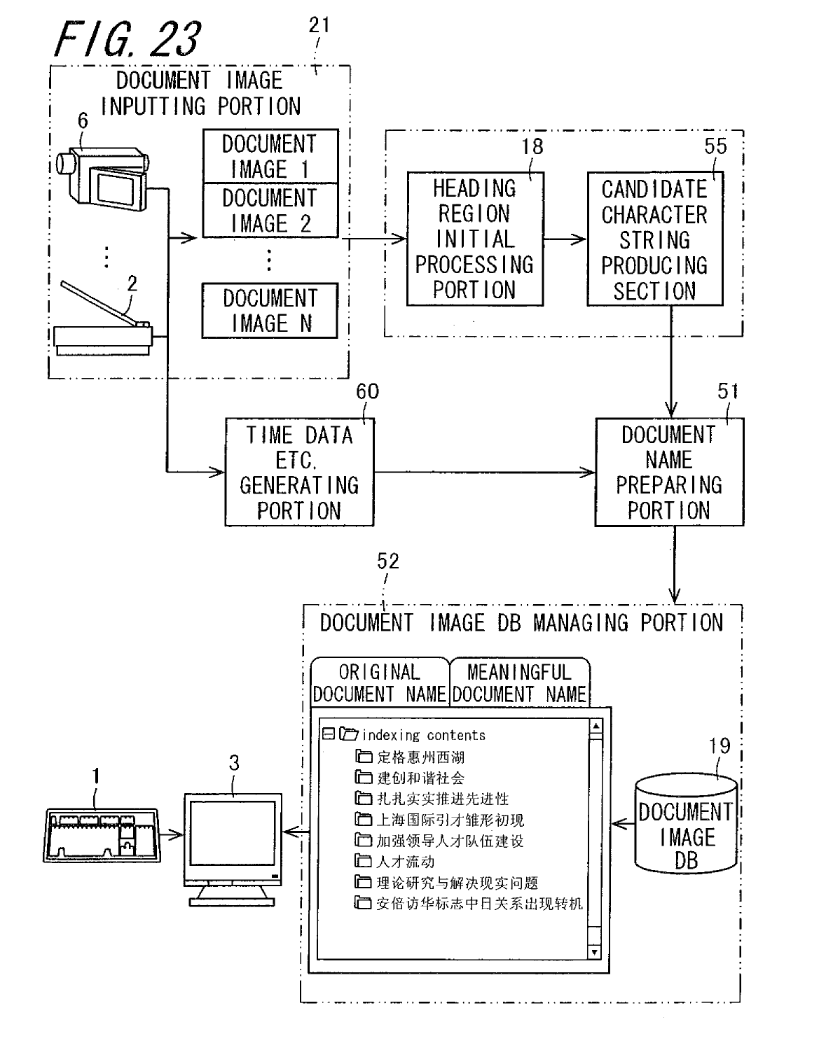

The document image managing process is described in reference to FIG. 23. The N pieces of document images, namely, the first document image through the N-th document image, are inputted from the document image inputting portion 21 which is constructed of the image scanner 2 or the digital photographic device 6.

The heading region initial processing portion 18 analyzes contents of the N pieces of respective document images thus inputted, and clips the heading regions to obtain character strings correspondingly. Next, although not illustrated in FIG. 23, the character image feature extracting portion 14, as mentioned above, divides the document images of the character strings included in the clipped heading regions into separated characters so as to extract image features of each of character images.

The candidate character string producing section 55 is constructed of the character image feature dictionary 15 and the feature similarity measurement portion 16. On the basis of the image features of images in the character strings clipped as has been described, the candidate character string producing section 55 selects characters having a high degree of similarity of image feature as candidate characters and prepares candidate character strings in accordance with the character strings included in the clipped heading regions. Simultaneously, the candidate character string producing section 55 adjusts the respective candidate characters constituting the candidate character strings by means of the lexical analysis method, so as to produce candidate character strings which make sense.

More specifically, based on the image features of character images extracted by the character image feature extracting portion 14, the candidate character string producing section 55 selects the N (N>1, integer) pieces of character images as candidate characters. The character images are selected from the character image feature dictionary 15 in descending order of degree of similarity of image feature. When the character number of the aforementioned string is M (M>1, integer), an index matrix of M×N cells is prepared. This process is performed by the aforementioned feature similarity measurement portion 16.

Next, on the basis of the prepared index matrix, the feature similarity measurement portion 16 prepares a candidate character string by sequentially arranging the first-column candidate characters of the respective rows of the prepared index matrix. And then, the semantic analysis is performed on the word composed of the candidate characters in the respective successive rows constituting the candidate string. And the first-column candidate characters in the respective rows are adjusted in such a manner as that the candidate character string has a meaning.

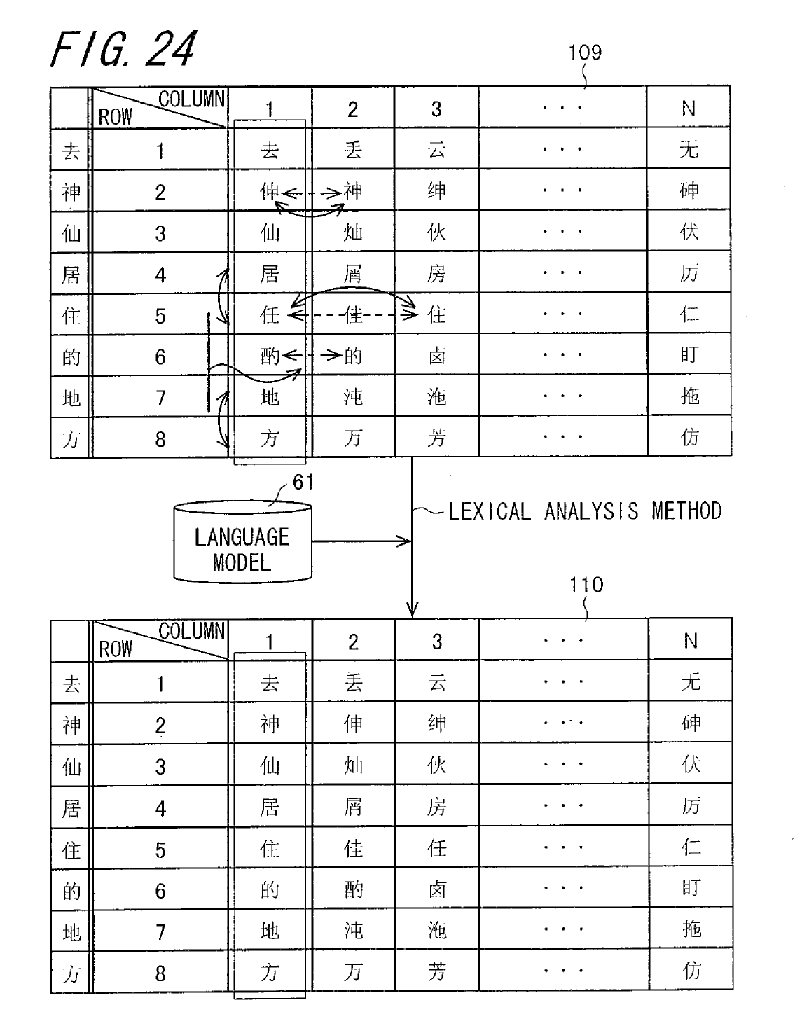

FIG. 24 is an illustration showing a specific example of index matrices before and after such an adjustment using the lexical analysis method that the character string of the first column in the prepared index matrix is adjusted into a character string which makes sense.

The upper part of the FIG. 24 shows an index matrix 109 before adjustment. The index matrix 109 is the same as the index matrix shown in Table 100 of FIG. 16. In this state, the index matrix is stored in the index information DB 17. There is no meaning indicated by a candidate character string of [symbol] [symbol] formed according to the index matrix 109 as has been mentioned heretofore.

With respect to a candidate character string that can be used as the meaningful document name, the conjunction relationship between a subject, a predicate, and an object must be correct semantically. Consequently, by means of the lexical analysis, the aforementioned character string is converted into a candidate character string which makes sense. Specifically, by use of a conceptual dictionary, semantic information is analyzed between the plurality of error candidate characters and the other words in the candidate text, so that the candidate character string is revised to be a candidate character string which makes sense.

A language model 61 used in the lexical analysis as has been mentioned heretofore, employs a large-volume corpus which includes related data of Chinese newspapers, Internet pages, and various media. For example, as an implementation example, a Bi-gram model (language model) can be used. The Bi-gram is a biliteral, bisyllabic, or bilexical group. The Bi-gram is generally employed to a large extent, as the basis of simple statistical analysis of text. When shown by symbol series, each symbol appearance is regarded as an independent event. The probability of the aforementioned symbol series is defined as will be described hereinbelow.

Note that the probability chain rule can be applied to the aforementioned function resolution. Chinese is regarded as an (N−1) order Markov chain (the probability of symbols is conditioned on previous appearance of the N−1 order symbol). This language character is referred to as an N-gram model.

The application of the established N-gram comprises statistical natural language processing which brings good results in a long period. The N-gram is composed commonly of statistics obtained by use of co-occurrence of characters and words in an entire text document of large size (i.e., corpus). The N-gram defines the establishment of the character chain or word chain. The N-gram has an advantage in its capability of covering a very large range of languages, compared to a common case where extraction is performed directly from the corpus. In the application to the language model, N is set at a value 2 to adopt the bi-gram model, in consideration of the limitation of computers and the properties of unlimited languages (characters and words exist indefinitely).

The lower part of FIG. 24 shows an index matrix 110 after adjustment. In the second row, the character [symbol] located in the firth column, which is recognized as an error candidate, is replaced by a character [symbol] in the second column. Similarly, in the fifth row, the character [symbol] in the first column is replaced by the character [symbol] in the third column. And then, the character [symbol] in the first column of the sixth row is recognized as an error candidate character in view of connection between the character [symbol] and the words [symbol] and [symbol] which are placed before and after the character

[symbol]

In this way, the candidate character string included in the first column of the index matrix 110 becomes a character string of [symbol] [symbol] which makes sense. Note that the feature similarity measurement portion 16 may be so prepared as to store the index matrix 110 adjusted as has been described heretofore, in the index information DB 17 where the index matrix 110 is then stored.

Back to FIG. 23, the candidate character strings which have been produced to make sense by the candidate character string producing section 55 as has been described, are sent to the document name preparing portion 51.

The document name preparing portion 51 prepares a document name of the inputted document image, which document name includes the candidate strings that have been produced to make sense by the candidate character string producing section 55. The document name including the candidate character string which makes sense, is referred to as “meaningful document name” hereinbelow.

Into the document name preparing portion 51, other data are also inputted that represent an input time and an input route of the document image, from the time data etc. generating portion 60. The document name preparing portion 51 also can produce a file name by use of the other data including at least the time data inputted from the time data etc. generating portion 60.

For example, of the other data such as the time data, the time data are included in a meaningful document name. The meaningful document name may be composed of the time data and the meaningful candidate character string.

Alternately, by use of the other data such as the time data, another document name may be prepared for the same document image. A document name composed of the other data such as the time data, is referred to as an original document name hereinbelow.

By composing the document names as have been described heretofore, it is possible to manage one document image by a meaningful document name and an original document name composed of the other data such as time data.

Meaningful document names and original document names produced corresponding to respective document images are sent to the document image DB managing portion 52, and are further stored in the document image DB 19, with responsive image data corresponding to the document names.

When a user gives an instruction of browsing a document image by use of an instruction inputting portion 54 shown is FIG. 10B, composed of the keyboard 1 and the like, the document image DB managing portion 52 displays a browsing screen on the document image displaying portion 53 shown in FIG. 10B, composed of the display apparatus 3 and the like.

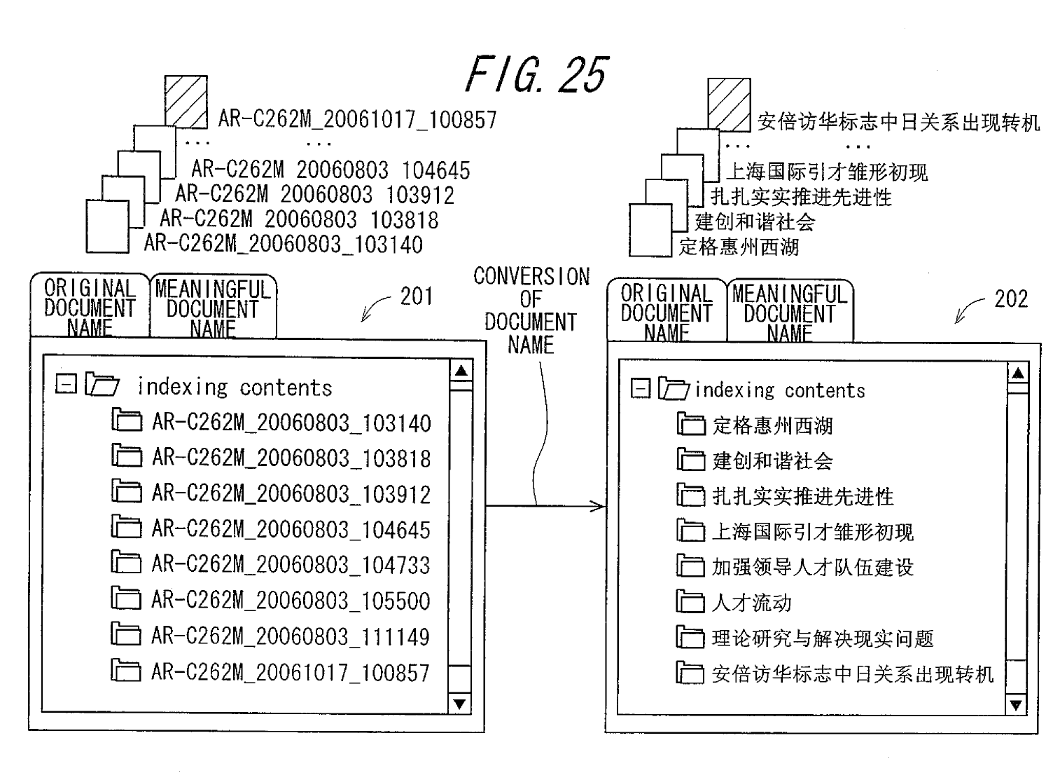

FIG. 25 shows one example of browsing screens, displayed by the document image displaying portion 53, of the document image stored in the document image DB 19.

A screen 201 shown on the left side of FIG. 25 shows a state where stored document images are displayed by a list of original document names thereof. An entry order of the respective document images is shown above the screen 201. A hithermost document image referred to as “AR C262M 20060803 103140” on the drawing sheet, is the document image inputted in the first place. Figures “20060803” represent that the input date is “Aug. 3, 2006”. Figures “103140” represent that the input time is “10:31:40”.

In the display state as has been described heretofore, an operation such as selecting a tag of meaningful document name displayed on the screen, causes a display of browsing screen to jump to a screen 202 shown on the left side of FIG. 25. The screen 202 shows a state where the stored document images are displayed by a list of the document names thereof.

The screen 202 corresponds to the screen 201, and also in the upper part of the screen 202, the hithermost document image referred to as a meaningful document name of [symbol] is the document image inputted in the first place.

In this way, the document images can be browsed in accordance with the meaningful document names, thus enabling a user to manage or search the stored document images with ease. Moreover, by preparing meaningful document names in conjunction with the original names, information such as time data and file names can be seen simultaneously.

Additionally, in the present document image processing apparatus 10, index information is prepared by use of the prepared index matrix. The index information is applied to the search process. For this reason, the heading region initial processing portion 18 clips a plurality of heading regions T included in document images and prepares index matrices for the respective heading regions T. However, if only aiming to prepare meaningful names for the document images, it is not necessary to clip the plurality of headlines included in the document images and prepare the index matrices for the respective clipped headlines.

That is, the document image processing apparatus may be so configured: preparing an index matrix for a character string of headline (character image string) included in a heading region which describes the document image the most aptly; and on the basis of this, employing a character string which is in similarity with the feature of the document image, to prepare a name which has a meaning.

The headline existing on the top row of the document image, for example, can be adopted as the heading region that describes the document image very aptly. This is due to that an important headline is inclined to be aligned on the top row of the document image correspondingly.

The size of the characters included in the heading region can be set to be greater than a certain size threshold and can be set to be greater than characters included in the other clipped heading regions. This is due to that compared to the other headlines, an important headline is inclined to be described in greater character size.

Alternately, the font type of the characters included in the heading region can be set different from those of the characters included in the other clipped heading regions. This is due to that an important headline is inclined to be described by characters having a font type different from that of characters included in the other headlines. Note that other standards other than the aforementioned ones can also be added. Further, the respective standards may be used either individually or in combination.

In addition, as in the case of the present document image processing apparatus 10, a document image processing apparatus may be constructed as to clip a plurality of heading regions from one document image and prepare index matrices for the respective heading regions thereof. In the constitution, the index matrix of the most important headline may be specified by the placement position of the heading region, the character size, or the character font. Moreover, particularly, being in this case, it is also preferable that a candidate character string be prepared so as to include a word which appears most frequently, based on the index matrices of the plurality of clipped heading regions.

Finally, a hardware logic circuit may be used to constitute respective blocks of the document image processing apparatus 10, particularly the character style normalization processing portion 12, the character image feature extracting portion 14, the feature similarity measurement portion 16, the heading region initial processing portion 18, the searching section 22, the lexical analyzing section 23, the document name preparing portion 51, the document image DB managing portion 52, and the like. Moreover, the aforementioned blocks may be realized by software by use of CPU, which will be described as follows.

That is, the document image processing apparatus 10 is provided with a central processing unit (abbreviated as CPU) for implementing a control program direction for realizing all the functions, a read-only memory (abbreviated as ROM) where the aforementioned program is stored, a random access memory (abbreviated as RAM) for developing the aforementioned program, a storage device which stores memory for storing the aforementioned program and all types of data and the like, and the like devices. And then, the object of the present invention can be achieved also by the following process: providing a recording medium recorded computer-readably with program codes to the aforementioned document image processing apparatus 10; and reading out, by means of the computer (or CPU or MPU), the program codes recorded on the recording medium. The recording medium records computer-readably program codes (executable format program, intermediate code program, and source program) of the control program of the document image processing apparatus 10. The control program is software to realize the aforementioned functions.

The aforementioned recording medium may be, for example, selected from a group including a tape recording medium, a disk recording medium, a card recording medium, and a semiconductor memory recording medium. The tape recording medium includes a magnetic tape or a cassette tape. The disk recording medium includes a magnetic disk such as a floppy (registered trademark) disk or a hard disk, and an optical disk such as CD-ROM, MO, MD, DVD, or CD-R. The card recording medium includes an IC card (including memory card) and an optical card. The semiconductor memory recording medium includes mask ROM, EPROM, EEPROM, and flash ROM.

Further, the document image processing apparatus 10 may be so configured as to be connectable to communication network through which the aforementioned program codes can be provided. The communication network which is not particularly limited, may be selected, for example, from a group including Internet, intranet, extranet, LAN, ISDN, VAN, CATV communication network, virtual private network, telephone line network, mobile communication network, satellite communication network, and the like. A transmission medium is not particularly limited, which may be either wired or wireless. The wired medium includes IEEE1394, USB, power-line carrier, cable TV line, telephone line, ADSL line, and the like. The wireless medium includes IrDA or remote infrared light, Bluetooth (registered trademark), 802.11 wireless network, HDR, a cellular phone network, a satellite connection, digital terrestrial network, and the like. In addition, the present invention can be realized also by using computer data signal embedded in the carrier wave, which is realized by electronic transmission of the aforementioned program codes.

The invention may be embodied in other specific forms without departing from the spirit or essential characteristics thereof. The present embodiments are therefore to be considered in all respects as illustrative and not restrictive, the scope of the invention being indicated by the appended claims rather than by the foregoing description and all changes which come within the meaning and the range of equivalency of the claims are therefore intended to be embraced therein.

What is claimed is:

1. A document image processing apparatus comprising:
a heading region storing portion for storing as a candidate character a character image having a high degree of similarity on each of character images in a plurality of heading regions in a document image;
a heading region extracting portion for extracting a heading region containing a search keyword by searching the heading region storing portion for each of search characters constituting the search keyword in an inputted search formula;
an order setting portion for setting in line with a predetermined rule an order of the heading regions extracted by the heading region extracting portion; and
a displaying portion for displaying a document image and highlighting on the displayed document image the heading regions extracted by the heading region extracting portion, in accordance with the order set by the order setting portion.

2. The document image processing apparatus of claim 1, wherein the heading region storing portion further stores position information of the plurality of the heading regions in the document image, and
the order setting portion sets the order of the heading region extracted by the heading region extracting portion, based on the position information of the heading region in the document image.

3. The document image processing apparatus of claim 1, wherein in a case where a number of search keywords contained in the inputted search formula is plural, the order setting portion sets the order of the heading regions extracted by the heading region extracting portion, based on the number of search keywords contained in the heading region.

4. The document image processing apparatus of claim 2, wherein in a case where a number of search keywords contained in the inputted search formula is plural, the order setting portion sets the order of the heading regions extracted by the heading region extracting portion, based on the number of search keywords contained in the heading region.

5. The document image processing apparatus of claim 1, wherein the order setting portion sets the order of the heading regions extracted by the heading region extracting portion, based on a number of characters in a character string part which is partially or totally in similarity with the search keyword.

6. The document image processing apparatus of claim 2, wherein the order setting portion sets the order of the heading regions extracted by the heading region extracting portion, based on a number of characters in a character string part which is partially or totally in similarity with the search keyword.

7. The document image processing apparatus of claim 1, wherein the order setting portion sets the order of the heading regions extracted by the heading region extracting portion, based on a size of a character image contained in the heading regions.

8. The document image processing apparatus of claim 2, wherein the order setting portion sets the order of the heading regions extracted by the heading region extracting portion, based on a size of a character image contained in the heading regions.

9. The document image processing apparatus of claim 1, wherein the order setting portion modifies a setting of the order of the heading regions extracted by the heading region extracting portion, in accordance with an inputted order-modifying command.

10. The document image processing apparatus of claim 2, wherein the order setting portion modifies a setting of the order of the heading regions extracted by the heading region extracting portion, in accordance with an inputted order-modifying command.

11. The document image processing apparatus of claim 3, wherein the order setting portion modifies a setting of the order of the heading regions extracted by the heading region extracting portion, in accordance with an inputted order-modifying command.

12. The document image processing apparatus of claim 4, wherein the order setting portion modifies a setting of the order of the heading regions extracted by the heading region extracting portion, in accordance with an inputted order-modifying command.

13. The document image processing apparatus of claim 5, wherein the order setting portion modifies a setting of the order of the heading regions extracted by the heading region extracting portion, in accordance with an inputted order-modifying command.

14. The document image processing apparatus of claim 6, wherein the order setting portion modifies a setting of the order of the heading regions extracted by the heading region extracting portion, in accordance with an inputted order-modifying command.

15. The document image processing apparatus of claim 7, wherein the order setting portion modifies a setting of the order of the heading regions extracted by the heading region extracting portion, in accordance with an inputted order-modifying command.

16. The document image processing apparatus of claim 8, wherein the order setting portion modifies a setting of the order of the heading regions extracted by the heading region extracting portion, in accordance with an inputted order-modifying command.

17. The document image processing apparatus of claim 1, wherein the displaying portion is capable of setting a display mode of highlight.

18. The document image processing apparatus of claim 2, wherein the displaying portion is capable of setting a display mode of highlight.

19. A document image processing method comprising:
a heading region storing step for storing as a candidate character a character image having a high degree of similarity on each of character images in a plurality of heading regions in a document image;
a heading region extracting step for extracting a heading region containing a search keyword by searching information stored in the heading region storing step for each of search characters constituting the search keyword in an inputted search formula;
an order setting step for setting in line with a predetermined rule an order of the heading regions extracted in the heading region extracting step; and
a displaying step for displaying a document image and highlighting the heading regions extracted in the heading region extracting step, in accordance with the order set in the order setting step.

20. A document image processing program for causing a computer to perform the document image processing method of claim 19.
